(19) United States
(12) Patent Application Publication
(10) Pub. No.: US 2025/0164360 A1
(43) Pub. Date: May 22, 2025

(54) ON-SLIDE SYNTHESIS OF A SCHIFF REAGENT

(71) Applicant: Ventana Medical Systems, Inc., Tucson, AZ (US)

(72) Inventors: Jean Marie Bird, Tucson, AZ (US); Mary Jo Castro Cantoria, Tucson, AZ (US); Edward E. Durrant, Oro Valley, AZ (US); Andrew Hannon, Tucson, AZ (US)

(21) Appl. No.: 18/966,253

(22) Filed: Dec. 3, 2024

Related U.S. Application Data
(63) Continuation of application No. PCT/US2023/022207, filed on May 15, 2023.
(60) Provisional application No. 63/366,091, filed on Jun. 9, 2022.

(51) Int. Cl. G01N 1/30; C09B 57/00; C09B 67/14

(52) U.S. Cl. CPC G01N 1/30; C09B 57/00; C09B 67/0017; G01N 2001/302

(57) ABSTRACT

The present disclosure is directed to compositions, kits, and methods for synthesizing a Schiff's reagent in situ, i.e., directly on a substrate, such as within a puddle disposed on the surface of a substrate. In some embodiments, the kits comprise at least a dye composition and a sulfite composition. In some embodiments, the dye composition comprises a compound having a 4-Benzhydrylidene-2,5-cyclohexadien-1-imine core functionalized to include at least two substituted or unsubstituted amine groups, wherein the compound has a molecular weight ranging from between about 300 g/mol to about 600 g/mol. In some embodiments, the dye composition optionally includes an acid. In some embodiments, the sulfite composition comprises a sulfite or SO₂ source.

### CROSS-REFERENCE TO RELATED APPLICATIONS

The present disclosure is a continuation of International Application No. PCT/US2023/022207 filed on May 15, 2023, which application claims the benefit of the filing date of U.S. Provisional Patent Application No. 63/366,091 filed on Jun. 9, 2022, the disclosure of which is hereby incorporated by reference herein in its entirety.

### FIELD OF THE INVENTION

The present disclosure relates to compositions and methods for staining biological specimens.

### BACKGROUND OF THE DISCLOSURE

The Periodic-Acid Schiff's assay (“PAS”) is a technique originally described by McManus in 1946 to visualize mucins, glycogen, basement membrane and fungal organisms through the combination of oxidation of polysaccharides by periodic acid and staining with the Schiff reagent. PAS is a versatile carbohydrate stain that can be used to detect structures containing a high proportion of carbohydrate macromolecules including polysaccharides. The main polysaccharide identified via histologic staining in human tissue sections is glycogen. PAS staining enables microscopic visualization and assessment of glycogen levels in tissue. Disruption in metabolic pathways that convert glucose to glycogen and vice versa can lead to glycogen accumulation. The PAS stain is also used in the examination of basement membranes and is typically used to inspect the glomerular basement membrane in renal biopsies suspected of glomerular disease. The PAS stain can also be used to detect glycogen present in fungal cell walls as an aid in diagnosis of fungal infection. The glycogen content of the fungal cell wall is similar across many fungi; therefore, PAS staining is a reliable method to confirm or eliminate the possibility of fungal infection.

The PAS assay is performed by reacting the analyte (e.g., a histological or cytological sample) with a predetermined quantity of a Schiff's reagent, such as commercially available Schiff's reagents. A Schiff's reagent may be derived from a single dye or a mixture of dyes, such as pararosaniline, rosaniline, Magenta II, and new fuchsine (see FIG. 1).

A solution including a Schiff's reagent will combine chemically with aldehydes in a sample to form a bright red, purple, or magenta product. As illustrated in FIG. 2A, a bisulfite molecule and a para-rosaniline dye react together to afford a decolorized adduct (see FIG. 2B) whose central carbon is sulfonated. The free and uncharged amine groups belonging to the aromatic ring react with the aldehyde group to form an aldimine. This aldimine group is electrophilic and, therefore, undergoes further reaction with the bisulfite ion. Finally, a red, purple or magenta colored bisulfite adduct is formed. Histologically, the aldehydes are either attached to, or produced from, a tissue structure. Therefore, the tissue structure itself becomes colored bright red. The mechanism is the same for all aldehydes in tissues. The aldehyde condenses with the Schiff's reagent to make a new compound attached to the tissue. In the process the chromophore reforms, and color is produced.

The Schiff reagent is an unstable reagent (see FIG. 3). As described in 1960 [Kasten, F. H. (1960): The Chemistry of Schiff Reagent, Intl. Rev. Cytol. 10:1-100.], the stability of the Schiff reagent ranges “from several hours to six months or longer, depending on the ingredients and the method of storing.” Due to this instability, storage and handling of the Schiff's reagent is restrictive and staining quality for the current PAS assay changes as the Schiff's reagent ages. Indeed, it has been shown that staining quality decreases with time once a vial of the Schiff's reagent is opened, e.g., after a vial has been opened for a month. In some embodiments, vials of commercial Schiff's reagent (opened and unopened) include crystalline precipitates (see FIG. 4), which, in some instances, may lead to false positives when used for staining, especially when detecting fungus in a biological sample. It is desirable to stain histological and/or cytological samples using a PAS Schiff reagent which is free from crystalline precipitates.

### BRIEF SUMMARY OF THE DISCLOSURE

Applicant has developed compositions, kits, and methods for synthesizing a Schiff's reagent in situ, i.e., directly on a substrate, such as within a puddle disposed on the surface of a substrate (e.g., a biological sample or microscope slide). The phrase “in situ synthesized Schiff's reagent” or the like refers to an adduct formed from a dye or mixture of dyes having a 4-Benzhydrylidene-2,5-cyclohexadien-1-imine core and a sulfite or SO₂ source. Applicant has unexpectedly discovered that synthesizing a Schiff's reagent in situ allows for consistent staining equivalent to that achieved using a commercial Schiff's reagent, while allowing for long term stability of reagents (e.g., having a stability of at least 1 year or at least 2 years). Moreover, synthesizing the Schiff's reagent in situ prevents the formation of precipitates, and thus avoids precipitates from being applied or dispensed to a substrate and/or puddle disposed on a substrate. In addition, the synthesis of a Schiff's reagent in situ allows staining intensity to be “dialed in” by changing the components (or the concentrations of components, e.g., dye concentration, acid concentration, and/or sulfite source concentration) used in the in situ synthesis and/or the reaction conditions (time, temperature) of the synthesis. These and other advantages are described herein.

A first aspect of the present disclosure is a dye composition comprising a compound having any one of Formulas (I)—(XII):

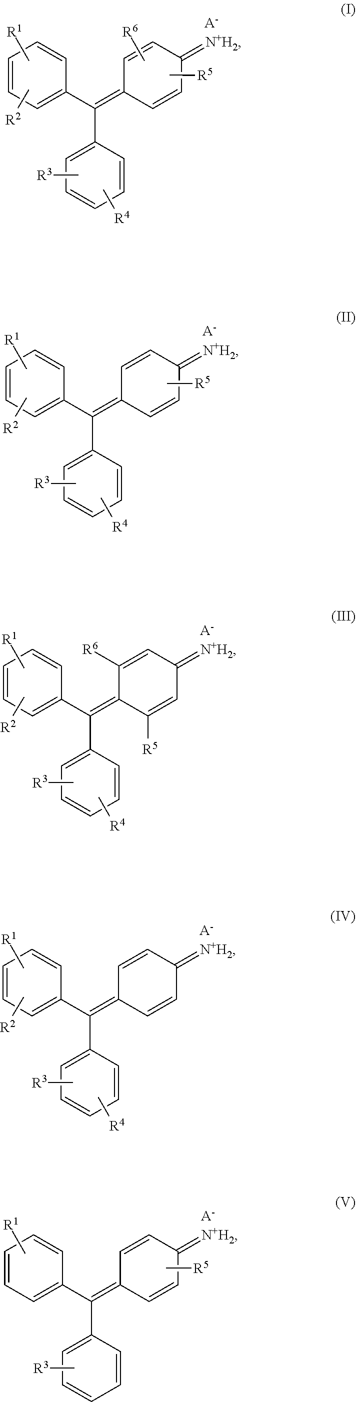

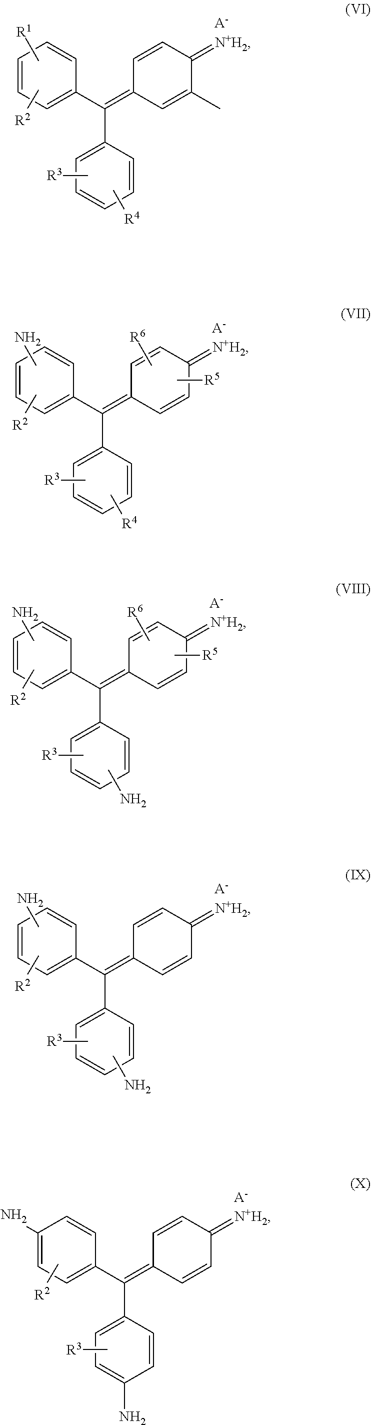

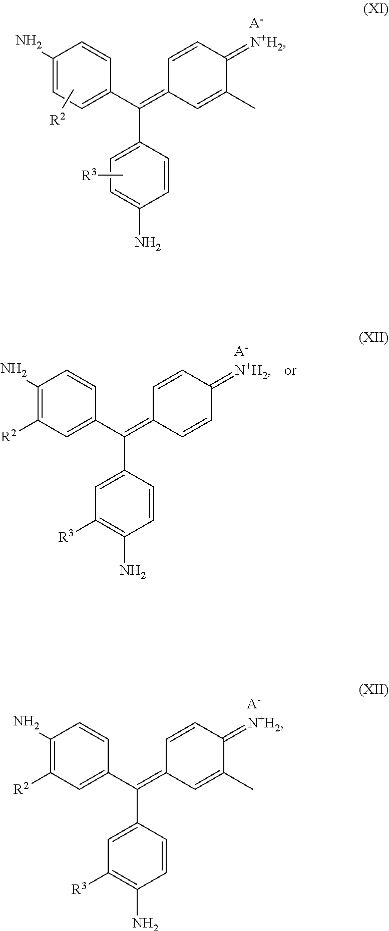

wherein
R¹, R², R³, R⁴, R⁵, and R⁶ are independently H, a halogen, a branched or unbranched, substituted or unsubstituted C₁-C₆ alkyl group or cycloalkyl group, —OH, —O—C₁-C₆ alkyl, or —N(R^{x})(R^{y}), where R^{x} and R^{y} are independently H or a branched or unbranched C₁-C₆ alkyl group optionally substituted with one or more halogen atoms, or where either R¹ and R² together, or R³ and R⁴ together, or R⁵ or R⁶ together form a 5- or 6-membered cyclic ring or heterocyclic ring which may be optionally substituted with one or more C₁-C₆ alkyl groups or one or more —N(R^{x})(R^{y}) groups; and wherein
A is a counterion; and
wherein a concentration of the compound having any one of Formulas (I)—(XII) ranges from between about 0.05% w/v to about 8% w/v by total volume of the dye composition.

In some embodiments, at least two of R¹, R², R³, R⁴, R⁵, and R⁶ are —N(R^{x})(R^{y}) and wherein at least another two of R¹, R², R³, R⁴, R⁵, and R⁶ are a branched or unbranched, substituted or unsubstituted C₁-C₆ alkyl group or cycloalkyl group; and wherein at least one of R^{x} or R^{y} is H. In some embodiments, at least two of R¹, R², R³, R⁴, R⁵, and R⁶ are —N(R^{x})(R^{y}) and wherein at least another two of R¹, R², R³, R⁴, R⁵, and R⁶ are C₁-C₂ alkyl group; and wherein at least one of R^{x} or R^{y} is H.

In some embodiments, the compound having any one of Formulas (I) to (XII) is selected from the group consisting of:

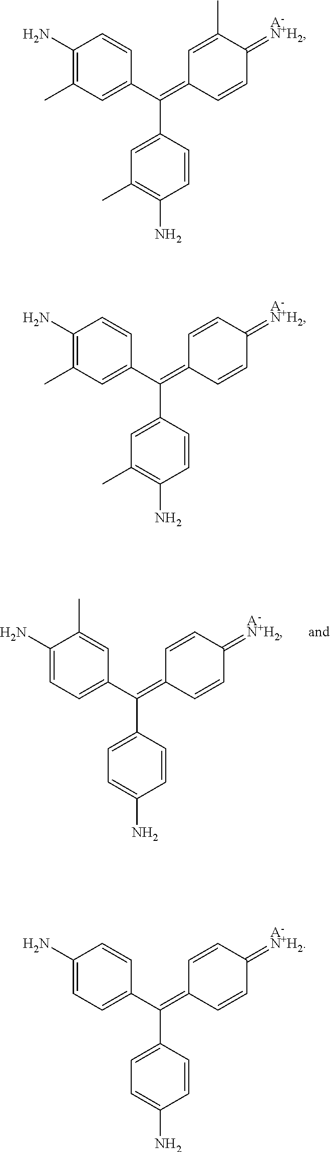

In some embodiments, the compound having any one of Formulas (I) to (XII) has a molecular weight ranging from between about 300 g/mol to about 600 g/mol. In some embodiments, the compound having any one of Formulas (I) to (XII) has a molecular weight ranging from between about 300 g/mol to about 425 g/mol. In some embodiments, the concentration ranges from between about 0.15% w/v to about 2.5% w/v by total volume of the dye composition. In some embodiments, the concentration ranges from between about 0.15% w/v to about 1.8% w/v by total volume of the dye composition.

In some embodiments, the dye composition further comprises an acid. In some embodiments, acid is a strong acid. In some embodiments, the strong acid is about 1M to about 1.3M hydrochloric acid. In some embodiments, the strong acid is about 1M to about 1.3M nitric acid. In some embodiments, the dye composition further comprises at least one of a solvent and/or an additive. In some embodiments, the dye composition further comprises a solvent and at least one additive. In some embodiments, the dye composition consists essentially of the compound having any one of Formulas (I) to (XII) and a strong acid.

A second aspect of the present disclosure is a sulfite composition comprising a sulfite or SO₂ source selected from the group consisting of metabisulfite, bisulfite, dithionite, thiosulfate, sulfites, and sulfurous acid; wherein a concentration of the sulfite or SO₂ source ranges from between about 0.1% w/v to about 18% w/v by total weight of the sulfite composition. In some embodiments, the concentration ranges from between about 1% w/v to about 9% w/v by total weight of the sulfite composition. In some embodiments, the concentration ranges from between about 1% w/v to about 4% w/v by total weight of the sulfite composition. In some embodiments, the sulfite or SO₂ source is not thiosulfate. In some embodiments, the sulfite composition further comprises an acid.

A third aspect of the present disclosure is a kit comprising (i) a dye composition; and (ii) a sulfite composition; wherein the dye composition comprises a compound having any one of Formulas (I)—(XII):

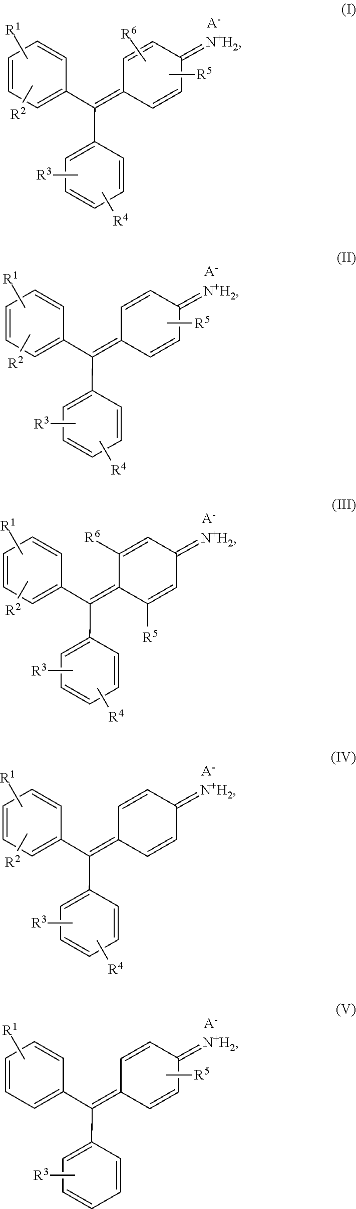

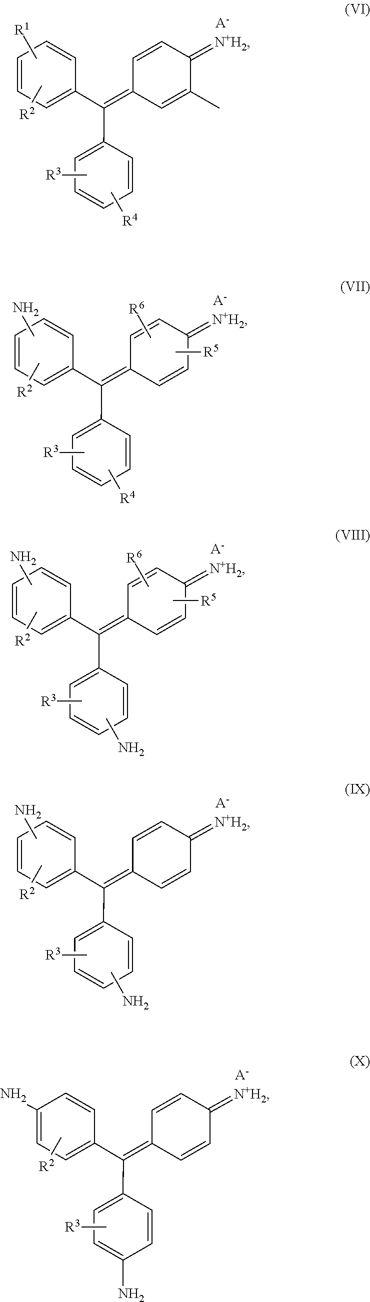

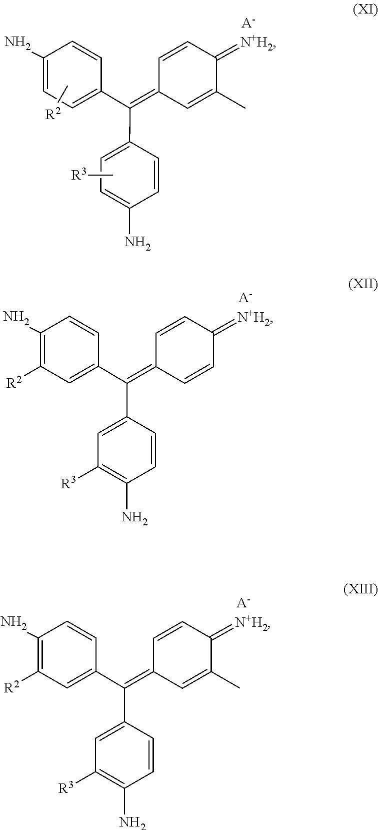

wherein
R¹, R², R³, R⁴, R⁵, and R⁶ are independently H, a halogen, a branched or unbranched, substituted or unsubstituted C₁-C₆ alkyl group or cycloalkyl group, —OH, —O—C₁-C₆ alkyl, or —N(R^{x})(R^{y}), where R^{x} and R^{y} are independently H or a branched or unbranched C₁-C₆ alkyl group optionally substituted with one or more halogen atoms, or where either R¹ and R² together, or R³ and R⁴ together, or R⁵ or R⁶ together form a 5- or 6-membered cyclic ring or heterocyclic ring which may be optionally substituted with one or more C₁-C₆ alkyl groups or one or more —N(R^{x})(R^{y}) groups; and
A is a counterion; and

wherein a concentration of the compound having any one of Formulas (I)—(XII) ranges from between about 0.05% w/v to about 8% w/v by total volume of the dye composition; and
wherein the sulfite composition comprises a sulfite or SO₂ source selected from the group consisting of metabisulfite, bisulfite, dithionite, thiosulfate, sulfites, and sulfurous acid; wherein a concentration of the sulfite or SO₂ source ranges from between about 0.1% w/v to about 18% w/v by total weight of the sulfite composition.

A fourth aspect of the present disclosure is a kit comprising (i) a dye composition free from an acid; (ii) a sulfite composition; and (iii) an acid, wherein the dye composition comprises a compound having any one of Formulas (I)—(XII):

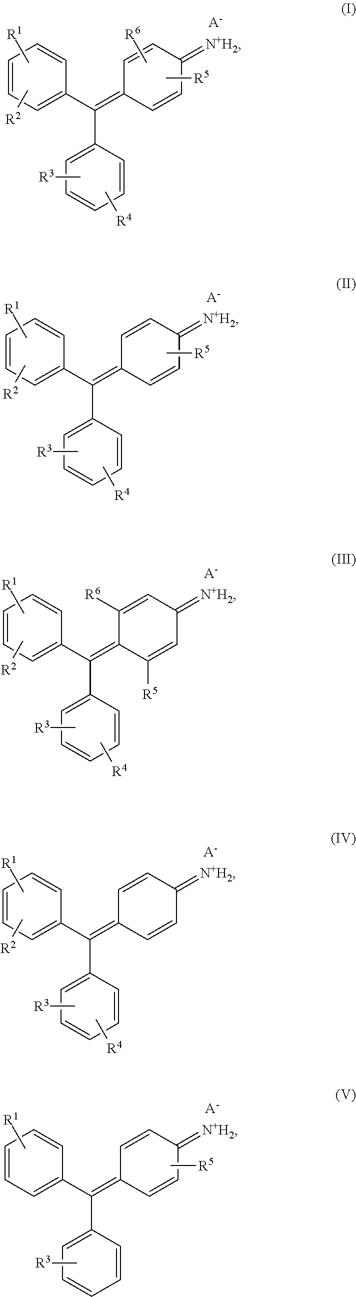

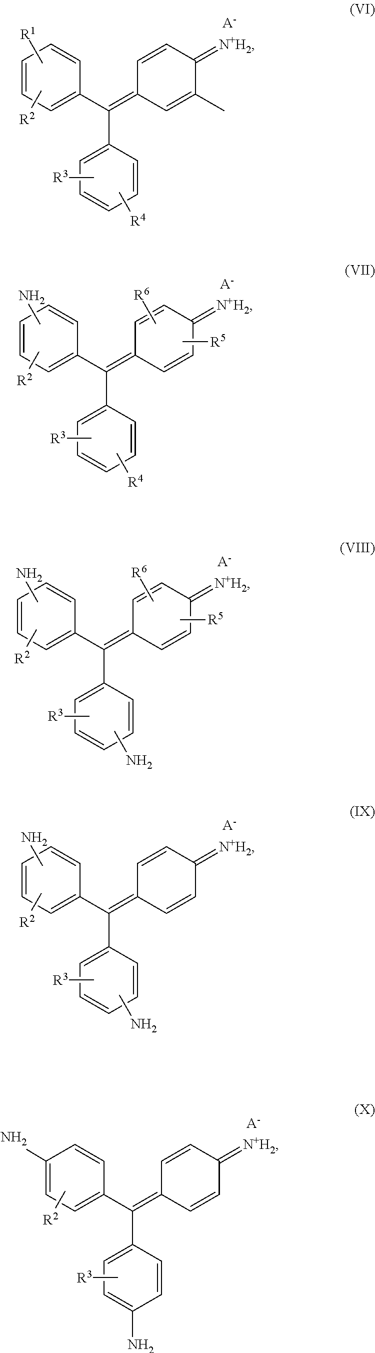

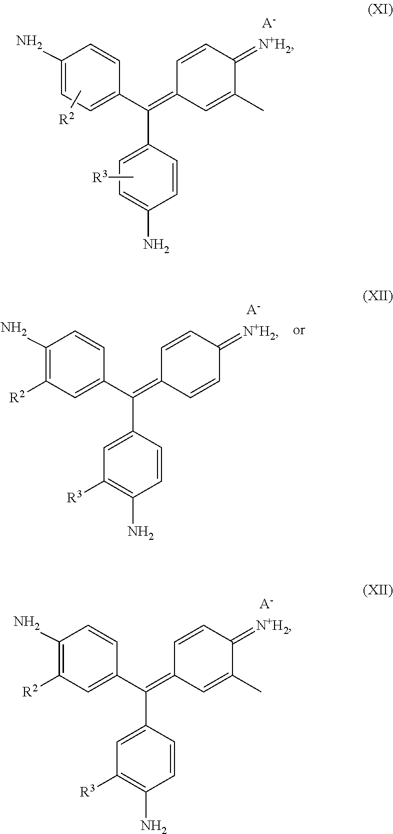

wherein
R¹, R², R³, R⁴, R⁵, and R⁶ are independently H, a halogen, a branched or unbranched, substituted or unsubstituted C₁-C₆ alkyl group or cycloalkyl group, —OH, —O—C₁-C₆ alkyl, or —N(R^{x})(R^{y}), where R^{x} and R^{y} are independently H or a branched or unbranched C₁-C₆ alkyl group optionally substituted with one or more halogen atoms, or where either R¹ and R² together, or R³ and R⁴ together, or R⁵ or R⁶ together form a 5- or 6-membered cyclic ring or heterocyclic ring which may be optionally substituted with one or more C₁-C₆ alkyl groups or one or more —N(R^{x})(R^{y}) groups; and
A is a counterion; and
wherein a concentration of the compound having any one of Formulas (I)—(XII) ranges from between about 0.05% w/v to about 8% w/v by total volume of the dye composition; and
wherein the sulfite composition comprises a sulfite or SO₂ source selected from the group consisting of metabisulfite, bisulfite, dithionite, thiosulfate, sulfites, and sulfurous acid; wherein a concentration of the sulfite or SO₂ source ranges from between about 0.1% w/v to about 18% w/v by total weight of the sulfite composition.

In some embodiments, at least two of R¹, R², R³, R⁴, R⁵, and R⁶ are —N(R^{x})(R^{y}) and wherein at least another two of R¹, R², R³, R⁴, R⁵, and R⁶ are a branched or unbranched, substituted or unsubstituted C₁-C₆ alkyl group or cycloalkyl group; and wherein at least one of R^{x} or R^{y} is H. In some embodiments, at least two of R¹, R², R³, R⁴, R⁵, and R⁶ are —N(R^{x})(R^{y}) and wherein at least another two of R¹, R², R³, R⁴, R⁵, and R⁶ are C₁-C₂ alkyl group; and wherein at least one of R^{x} or R^{y} is H.

In some embodiments, the compound having any one of Formulas (I) to (XII) is selected from the group consisting of:

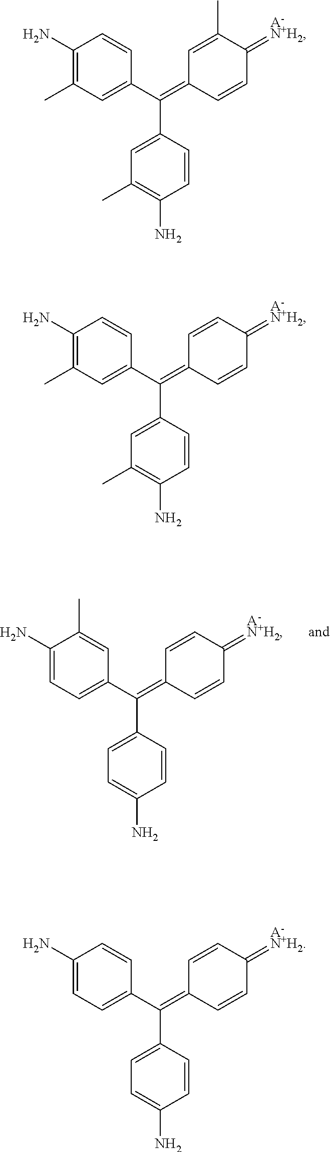

In some embodiments, the compound having any one of Formulas (I) to (XII) has a molecular weight ranging from between about 300 g/mol to about 600 g/mol. In some embodiments, the compound having any one of Formulas (I) to (XII) has a molecular weight ranging from between about 300 g/mol to about 425 g/mol. In some embodiments, the concentration ranges from between about 0.15% w/v to about 2.5% w/v by total volume of the dye composition. In some embodiments, the concentration ranges from between about 0.15% w/v to about 1.8% w/v by total volume of the dye composition.

In some embodiments, the sulfite composition comprises a sulfite or SO₂ source selected from the group consisting of metabisulfite, bisulfite, dithionite, thiosulfate, sulfites, and sulfurous acid; wherein a concentration of the sulfite or SO₂ source ranges from between about 0.1% w/v to about 18% w/v by total weight of the sulfite composition. In some embodiments, the wherein the concentration ranges from between about 1% w/v to about 9% w/v by total weight of the sulfite composition. In some embodiments, the concentration ranges from between about 1% w/v to about 4% w/v by total weight of the sulfite composition.

In some embodiments, the acid is a strong acid. In some embodiments, the acid is selected from the group consisting of hydrochloric acid, hydrobromic acid, hydrofluoric, trifluoracetic, hydroiodic acid, sulfuric acid, nitric acid, chloric acid, and perchloric acid.

A fifth aspect of the present disclosure is a method of staining a biological sample, the method comprising sequentially dispensing a dye composition and a sulfite composition to the biological sample; wherein the dye composition comprises a compound having any one of Formulas (I)—(XII):

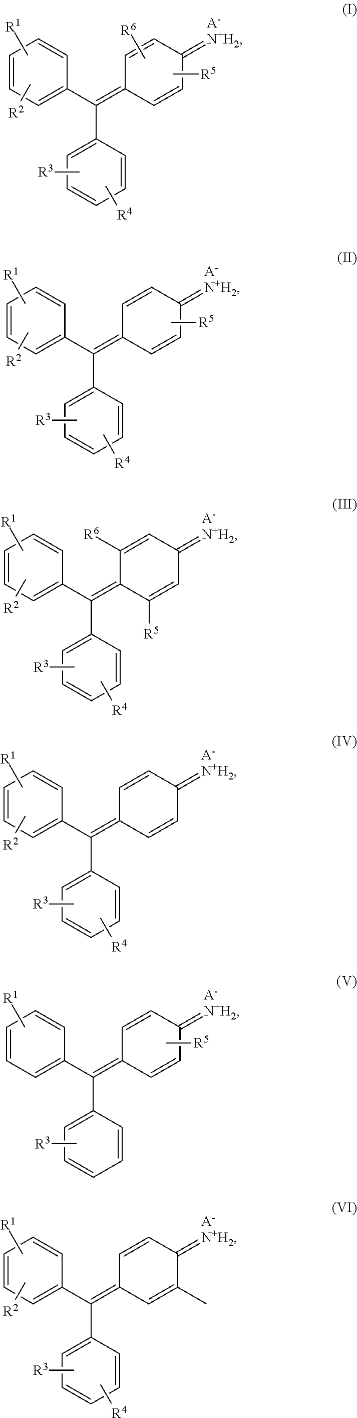

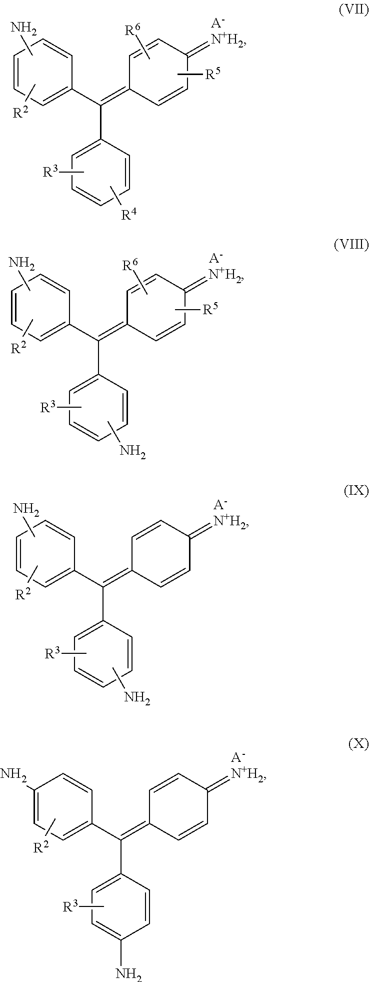

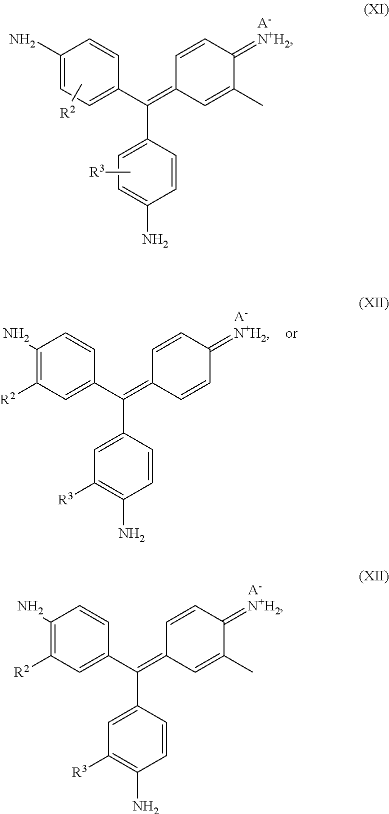

wherein
R¹, R², R³, R⁴, R⁵, and R⁶ are independently H, a halogen, a branched or unbranched, substituted or unsubstituted C₁-C₆ alkyl group or cycloalkyl group, —OH, —O—C₁-C₆ alkyl, or —N(R^{x})(R^{y}), where R^{x} and R^{y} are independently H or a branched or unbranched C₁-C₆ alkyl group optionally substituted with one or more halogen atoms, or where either R¹ and R² together, or R³ and R⁴ together, or R⁵ or R⁶ together form a 5- or 6-membered cyclic ring or heterocyclic ring which may be optionally substituted with one or more C₁-C₆ alkyl groups or one or more —N(R^{x})(R^{y}) groups; and
A is a counterion; and
wherein a concentration of the compound having any one of Formulas (I)—(XII) ranges from between about 0.05% w/v to about 8% w/v by total volume of the dye composition; and
wherein the sulfite composition comprises a sulfite or SO₂ source selected from the group consisting of metabisulfite, bisulfite, dithionite, thiosulfate, sulfites, and sulfurous acid; wherein a concentration of the sulfite or SO₂ source ranges from between about 0.1% w/v to about 18% w/v by total weight of the sulfite composition.

In some embodiments, the dye composition further includes an acid. In some embodiments, the acid is a strong acid. In some embodiments, the dye composition further includes hydrochloric acid. In some embodiments, the dye composition further includes nitric acid.

In some embodiments, the dye composition is dispensed prior to the sulfite composition. In other embodiments, the dye composition is dispensed after the sulfite composition is dispensed. In some embodiments, the temperature of the sample, the dye composition, and/or the sulfite composition ranges from between 30° C. to about 50° C. In some embodiments, the temperature of the sample, the dye composition, and/or the sulfite composition ranges from between 30° C. to about 40° C. In some embodiments, the sequentially dispensed dye composition and the sulfite composition are allowed to remain in contact with the sample for at least 4 minutes. In some embodiments, the sequentially dispensed dye composition and the sulfite composition are allowed to remain in contact with the sample for at least 8 minutes.

In some embodiments, an amount of the dye composition dispensed to the sample ranges from between about 50 μL to about 200 μL; and wherein an amount of the sulfite composition dispensed to the sample ranges from between about 50 μL to about 200 μL. In some embodiments, an amount of the dye composition dispensed to the sample ranges from between about 100 μL to about 200 μL; and wherein an amount of the sulfite composition dispensed to the sample ranges from between about 100 μL to about 200 μL. In some embodiments, an amount of the dye composition dispensed to the sample ranges from between about 100 μL to about 150 μL; and wherein an amount of the sulfite composition dispensed to the sample ranges from between about 100 μL to about 150 μL.

In some embodiments, the sample is pretreated with a reagent that forms aldehyde groups for a predetermined amount of time prior to dispensing the dye composition and/or the sulfite composition. In some embodiments, the sample is pre-treated with periodic acid (e.g., 1 gram of periodic acid in 100 ml of water) for a predetermined amount of time, for example between about one minute and about 10 minutes.

A sixth aspect of the present disclosure is a method of staining a biological sample, the method comprising simultaneously dispensing a dye composition and a sulfite composition to the biological sample; wherein the dye composition comprises a compound having any one of Formulas (I)—(XII):

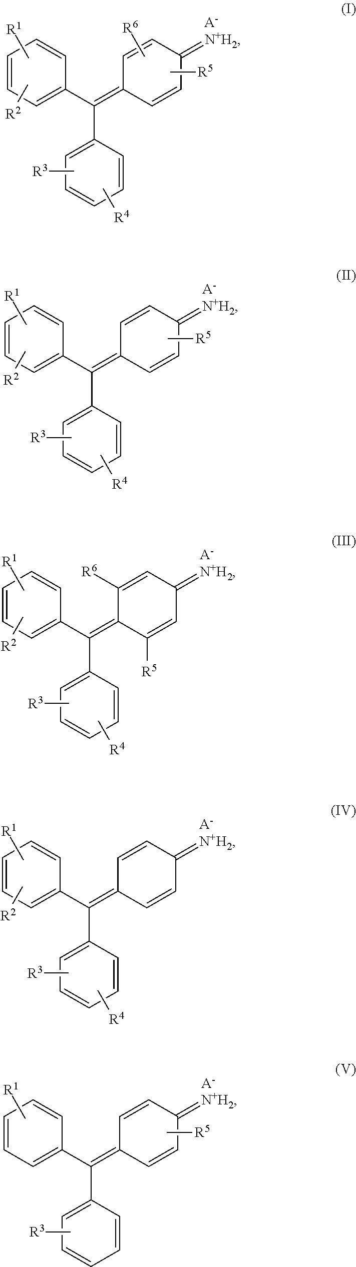

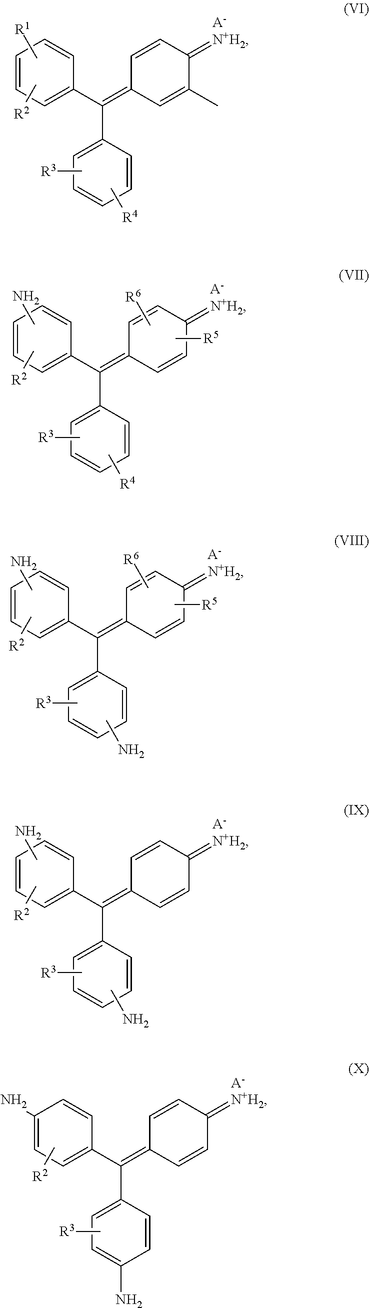

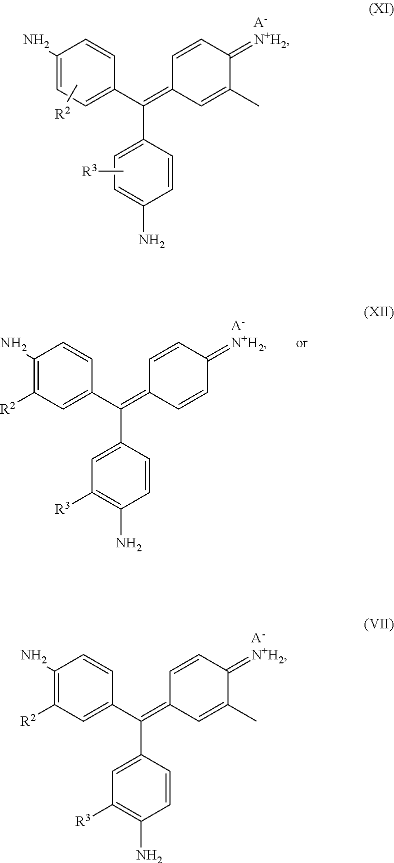

wherein
R¹, R², R³, R⁴, R⁵, and R⁶ are independently H, a halogen, a branched or unbranched, substituted or unsubstituted C₁-C₆ alkyl group or cycloalkyl group, —OH, —O—C₁-C₆ alkyl, or —N(R^{x})(R^{y}), where R^{x} and R^{y} are independently H or a branched or unbranched C₁-C₆ alkyl group optionally substituted with one or more halogen atoms, or where either R¹ and R² together, or R³ and R⁴ together, or R⁵ or R⁶ together form a 5- or 6-membered cyclic ring or heterocyclic ring which may be optionally substituted with one or more C₁-C₆ alkyl groups or one or more —N(R^{x})(R^{y}) groups; and
A is a counterion; and
wherein a concentration of the compound having any one of Formulas (I)—(XII) ranges from between about 0.05% w/v to about 8% w/v by total volume of the dye composition; and
wherein the sulfite composition comprises a sulfite or SO₂ source selected from the group consisting of metabisulfite, bisulfite, dithionite, thiosulfate, sulfites, and sulfurous acid; wherein a concentration of the sulfite or SO₂ source ranges from between about 0.1% w/v to about 18% w/v by total weight of the sulfite composition.

In some embodiments, the temperature of the sample, the dye composition, and/or the sulfite composition ranges from between 30° C. to about 50° C. In some embodiments, the temperature of the sample, the dye composition, and/or the sulfite composition ranges from between 30° C. to about 40° C. In some embodiments, the simultaneously dispensed dye composition and sulfite composition are allowed to remain in contact with the sample for at least 4 minutes. In some embodiments, the simultaneously dispensed dye composition and sulfite composition are allowed to remain in contact with the sample for at least 8 minutes.

In some embodiments, an amount of the dye composition dispensed to the sample ranges from between about 50 μL to about 200 μL; and wherein an amount of the sulfite composition dispensed to the sample ranges from between about 50 μL to about 200 μL. In some embodiments, an amount of the dye composition dispensed to the sample ranges from between about 100 μL to about 200 μL; and wherein an amount of the sulfite composition dispensed to the sample ranges from between about 100 μL to about 200 μL. In some embodiments, an amount of the dye composition dispensed to the sample ranges from between about 100 μL to about 150 μL; and wherein an amount of the sulfite composition dispensed to the sample ranges from between about 100 μL to about 150 μL.

In some embodiments, the sample is pretreated with a reagent that forms aldehyde groups for a predetermined amount of time prior to dispensing the dye composition and/or the sulfite composition. In some embodiments, the sample is pre-treated with periodic acid (e.g., 1 gram of periodic acid in 100 ml of water) for a predetermined amount of time, for example between about one minute and about 10 minutes.

A seventh aspect of the present disclosure is a method of staining a biological sample, the method comprising sequentially dispensing a dye composition, a sulfite composition, and an acid to the biological sample; wherein the dye composition comprises a compound having any one of Formulas (I)—(XII):

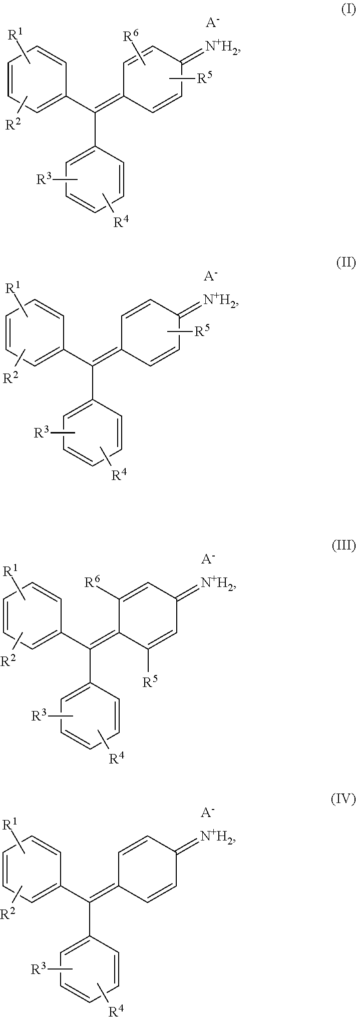

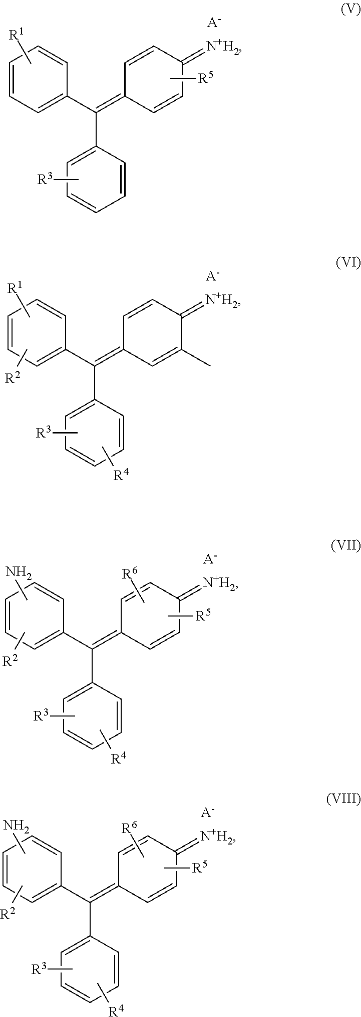

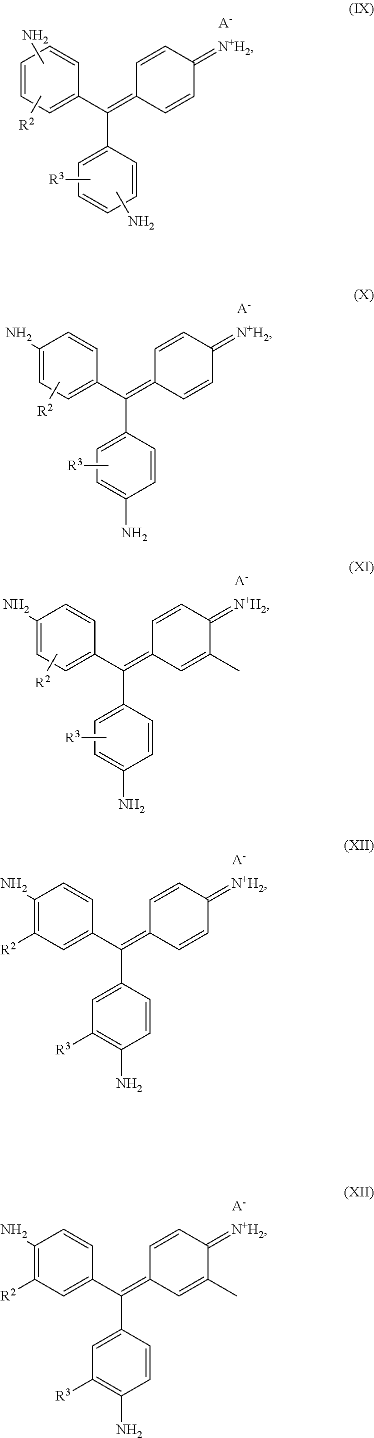

wherein
R¹, R², R³, R⁴, R⁵, and R⁶ are independently H, a halogen, a branched or unbranched, substituted or unsubstituted C₁-C₆ alkyl group or cycloalkyl group, —OH, —O—C₁-C₆ alkyl, or —N(R^{x})(R^{y}), where R^{x} and R^{y} are independently H or a branched or unbranched C₁-C₆ alkyl group optionally substituted with one or more halogen atoms, or where either R¹ and R² together, or R³ and R⁴ together, or R⁵ or R⁶ together form a 5- or 6-membered cyclic ring or heterocyclic ring which may be optionally substituted with one or more C₁-C₆ alkyl groups or one or more —N(R^{x})(R^{y}) groups; and
A is a counterion; and
wherein a concentration of the compound having any one of Formulas (I)—(XII) ranges from between about 0.05% w/v to about 8% w/v by total volume of the dye composition; and
wherein the sulfite composition comprises a sulfite or SO₂ source selected from the group consisting of metabisulfite, bisulfite, dithionite, thiosulfate, sulfites, and sulfurous acid;
wherein a concentration of the sulfite or SO₂ source ranges from between about 0.1% w/v to about 18% w/v by total weight of the sulfite composition.

In some embodiments, the dye composition is dispensed prior to the dispensing of the sulfite composition and/or the acid. In some embodiments, the temperature of the sample, the dye composition, the acid, and/or the sulfite composition ranges from between 30° C. to about 50° C. In some embodiments, the temperature of the sample, the dye composition, the acid, and/or the sulfite composition ranges from between 30° C. to about 40° C. In some embodiments, the sequentially dispensed dye composition, the acid, and the sulfite composition are allowed to remain in contact with the sample for at least 4 minutes. In some embodiments, the sequentially dispensed dye composition, the acid, and the sulfite composition are allowed to remain in contact with the sample for at least 8 minutes.

In some embodiments, an amount of the dye composition dispensed to the sample ranges from between about 50 μL to about 200 μL; wherein an amount of the acid dispensed to the sample ranges from between about 50 μL to about 200 μL; and wherein an amount of the sulfite composition dispensed to the sample ranges from between about 50 μL to about 200 μL. In some embodiments, an amount of the dye composition dispensed to the sample ranges from between about 100 μL to about 200 μL; wherein an amount of the acid dispensed to the sample ranges from between about 100 μL to about 200 μL; and wherein an amount of the sulfite composition dispensed to the sample ranges from between about 100 μL to about 200 μL. In some embodiments, an amount of the dye composition dispensed to the sample ranges from between about 100 μL to about 150 μL; wherein an amount of the acid dispensed to the sample ranges from between about 100 μL to about 150 μL; and wherein an amount of the sulfite composition dispensed to the sample ranges from between about 100 μL to about 150 μL.

In some environments, the acid is a strong acid. In some embodiments, the strong acid is hydrochloric acid. In some embodiments, the strong acid is nitric acid.

In some embodiments, the sample is pretreated with a reagent that forms aldehyde groups for a predetermined amount of time prior to dispensing the dye composition, the acid, and/or the sulfite composition. In some embodiments, the sample is pre-treated with periodic acid (e.g., 1 gram of periodic acid in 100 ml of water) for a predetermined amount of time, for example between about one minute and about 10 minutes.

An eighth aspect of the present disclosure is a method of staining a biological sample, the method comprising simultaneously dispensing a dye composition, a sulfite composition, and an acid to the biological sample; wherein the dye composition comprises a compound having any one of Formulas (I)—(XII):

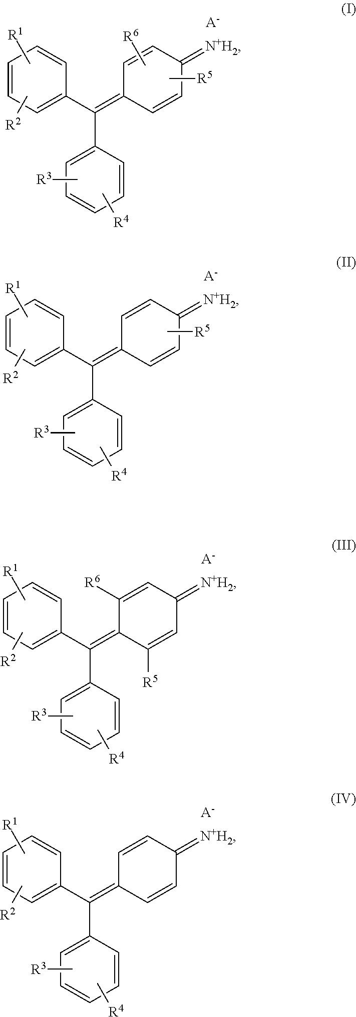

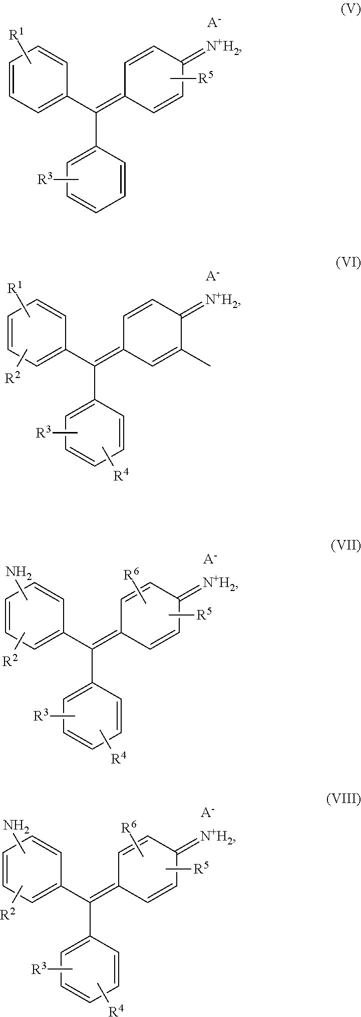

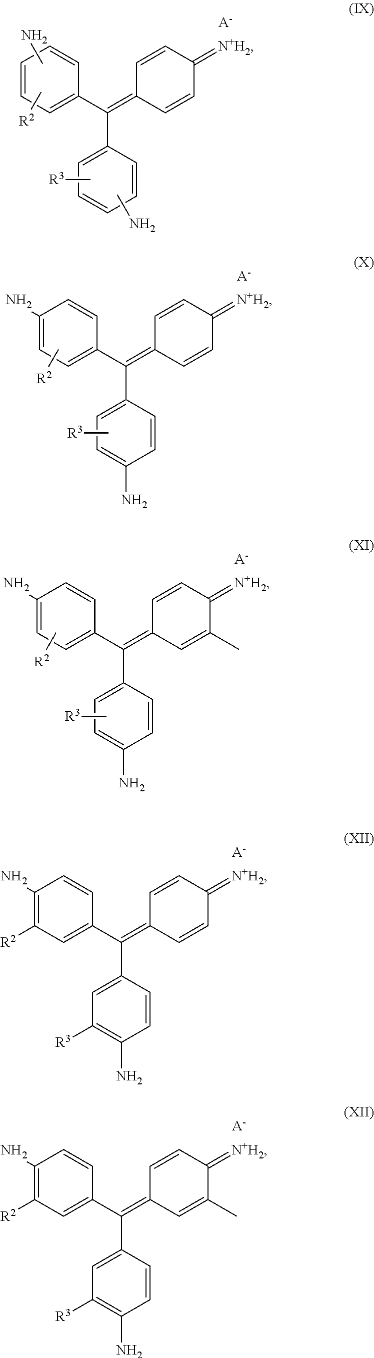

wherein
R¹, R², R³, R⁴, R⁵, and R⁶ are independently H, a halogen, a branched or unbranched, substituted or unsubstituted C₁-C₆ alkyl group or cycloalkyl group, —OH, —O—C₁-C₆ alkyl, or —N(R^{x})(R^{y}), where R^{x} and R^{y} are independently H or a branched or unbranched C₁-C₆ alkyl group optionally substituted with one or more halogen atoms, or where either R¹ and R² together, or R³ and R⁴ together, or R⁵ or R⁶ together form a 5- or 6-membered cyclic ring or heterocyclic ring which may be optionally substituted with one or more C₁-C₆ alkyl groups or one or more —N(R^{x})(R^{y}) groups; and
A is a counterion; and
wherein a concentration of the compound having any one of Formulas (I)—(XII) ranges from between about 0.05% w/v to about 8% w/v by total volume of the dye composition; and
wherein the sulfite composition comprises a sulfite or SO₂ source selected from the group consisting of metabisulfite, bisulfite, dithionite, thiosulfate, sulfites, and sulfurous acid; wherein a concentration of the sulfite or SO₂ source ranges from between about 0.1% w/v to about 18% w/v by total weight of the sulfite composition.

In some embodiments, the temperature of the sample, the dye composition, the acid, and/or the sulfite composition ranges from between 30° C. to about 50° C. In some embodiments, the temperature of the sample, the dye composition, the acid, and/or the sulfite composition ranges from between 30° C. to about 40° C. In some embodiments, the simultaneously dispensed dye composition, the acid, and the sulfite composition are allowed to remain in contact with the sample for at least 4 minutes. In some embodiments, the simultaneously dispensed dye composition, the acid, and the sulfite composition are allowed to remain in contact with the sample for at least 8 minutes.

In some embodiments, an amount of the dye composition dispensed to the sample ranges from between about 50 μL to about 200 μL; wherein an amount of the acid dispensed to the sample ranges from between about 50 μL to about 200 μL; and wherein an amount of the sulfite composition dispensed to the sample ranges from between about 50 μL to about 200 μL. In some embodiments, an amount of the dye composition dispensed to the sample ranges from between about 100 μL to about 200 μL; wherein an amount of the acid dispensed to the sample ranges from between about 100 μL to about 200 μL; and wherein an amount of the sulfite composition dispensed to the sample ranges from between about 100 μL to about 200 μL. In some embodiments, an amount of the dye composition dispensed to the sample ranges from between about 100 μL to about 150 μL; wherein an amount of the acid dispensed to the sample ranges from between about 100 μL to about 150 μL; and wherein an amount of the sulfite composition dispensed to the sample ranges from between about 100 μL to about 150 μL.

In some environments, the acid is a strong acid. In some embodiments, the strong acid is hydrochloric acid. In some embodiments, the strong acid is nitric acid.

In some embodiments, the sample is pretreated with a reagent that forms aldehyde groups for a predetermined amount of time prior to dispensing the dye composition, the acid, and/or the sulfite composition. In some embodiments, the sample is pre-treated with periodic acid (e.g., 1 gram of periodic acid in 100 ml of water) for a predetermined amount of time, for example between about one minute and about 10 minutes.

A ninth aspect of the present disclosure is a stained biological sample, the stained biological sample prepared by (i) dispensing a dye composition to the biological sample, the dye composition comprising (a) a compound having a 4-Benzhydrylidene-2,5-cyclohexadien-1-imine core functionalized to include at least two substituted or unsubstituted amine groups, wherein the compound has a molecular weight ranging from between about 300 g/mol to about 600 g/mol; and (b) an acid; and wherein a concentration of the compound ranges from between about 0.15% w/v to about 2.5% w/v by total volume of the dye composition; and (ii) dispensing a sulfite composition comprising a sulfite or SO₂ source, wherein a concentration of the sulfite or SO₂ source ranges from between about 0.1% w/v to about 18% w/v by total weight of the sulfite composition. In some embodiments, the dye composition is dispensed first to the biological sample. In some embodiments, the dye composition and the sulfite composition are dispensed simultaneously. In some embodiments, the acid is a strong acid.

In some embodiments, the sample is pretreated with a reagent that forms aldehyde groups for a predetermined amount of time prior to dispensing the dye composition and/or the sulfite composition. In some embodiments, the sample is pre-treated with periodic acid (e.g., 1 gram of periodic acid in 100 mL of water) for a predetermined amount of time, for example between about one minute and about 10 minutes.

In some embodiments, the acid is hydrochloric acid or nitric acid. In some embodiments, the compound is selected from the group consisting of:

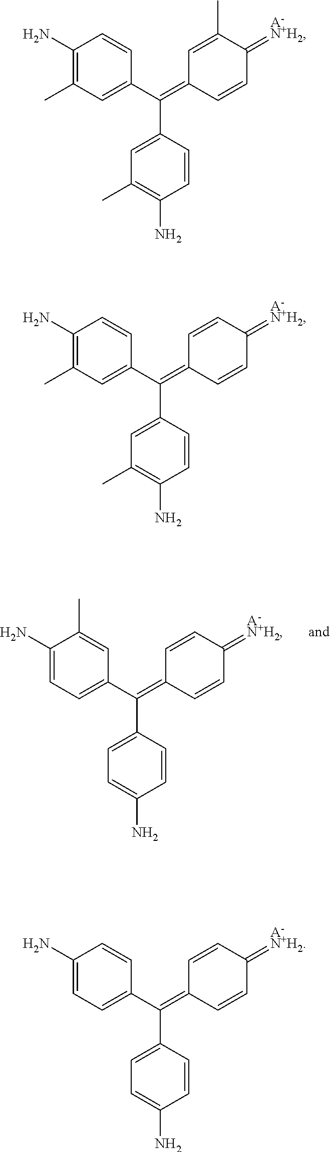

### BRIEF DESCRIPTION OF THE FIGURES

The patent or application file contains at least one drawing executed in color. Copies of this patent or patent application publication with color drawings will be provided to the Office upon request and the payment of the necessary fee.

FIG. 1 depicts various dyes which may be reacted with a sulfite or a SO₂ source to form a Schiff's reagent.

FIG. 2A illustrates the reaction between bisulfite and para-rosaniline to afford a decolorized adduct.

FIG. 2B illustrates a decolorized Schiff's reagent.

FIG. 3 illustrates the stability of a Schiff's reagent derived from pararosaniline when exposed to an oxidant.

FIG. 4 depicts a tissue sample stained using a PAS Schiff's reagent, where crystalline precipitates formed during storage of the PAS Schiff reagent were deposited onto the tissue sample.

FIG. 5 depicts an overall method of preparing a Schiff's reagent in situ.

FIGS. 6A and 6B illustrate staining of a tissue sample performed using an in situ synthesized Schiff's reagent prepared from pararosaniline dyes stored for two weeks either at 2° C.-8° C. or at 60° C.

FIGS. 6C and 6D show staining of a tissue sample performed using commercial Schiff's reagents which were new (FIG. 6C) and opened for two weeks (FIG. 6D).

FIGS. 7A and 7B demonstrates staining intensity and contrast using an in situ synthesized Schiff's reagent as a function of reaction time.

FIG. 7C illustrates a control sample stained using a commercial Schiff's reagent.

FIGS. 8A and 8B demonstrates staining intensity and contrast using an in situ synthesized Schiff's reagent as a function of the concentrations of the dye and sulfite/SO₂ source.

FIG. 8C illustrates a control sample stained using a commercial Schiff's reagent.

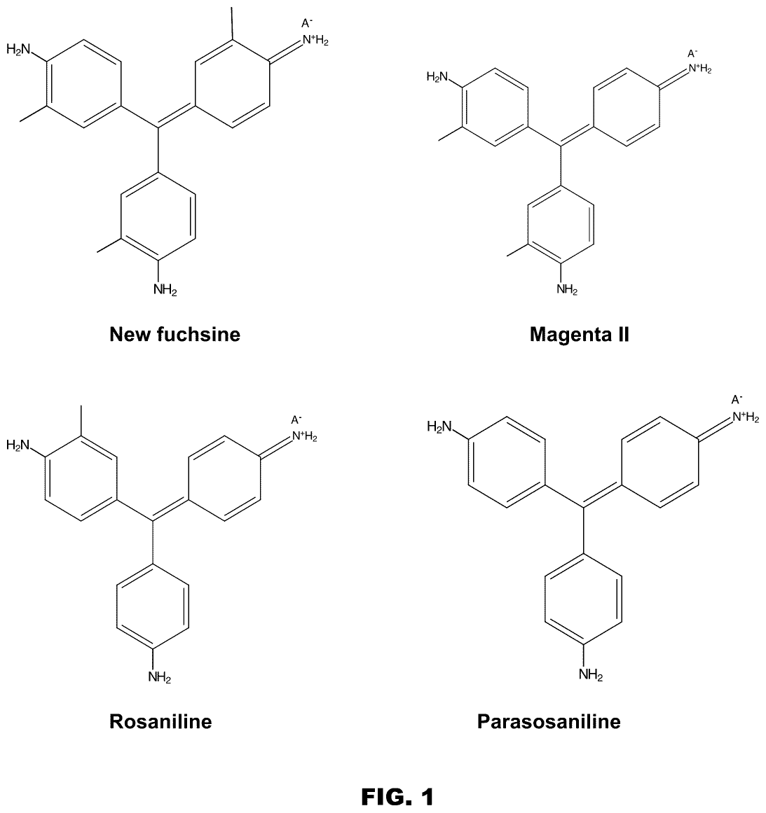

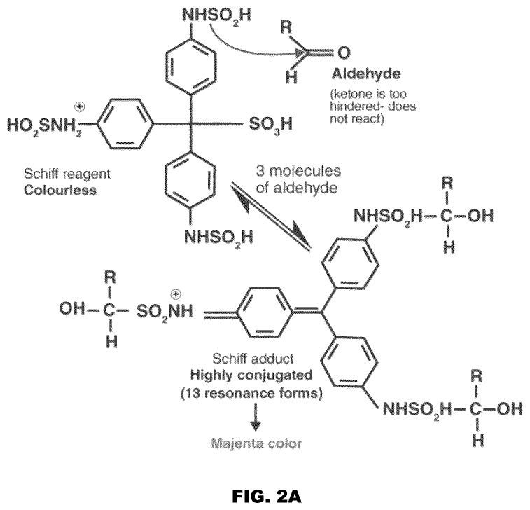

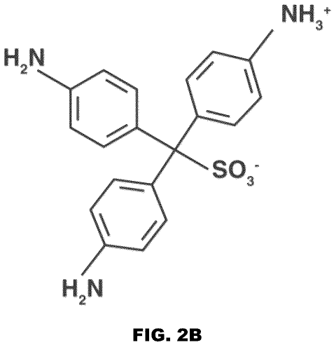

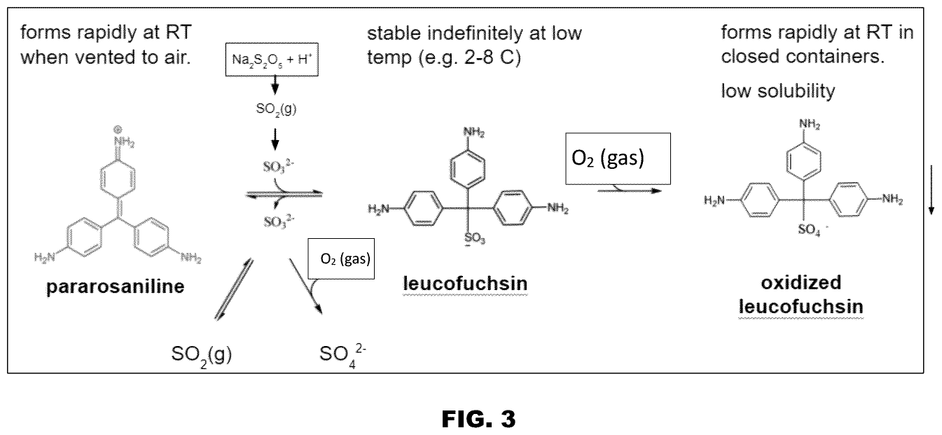

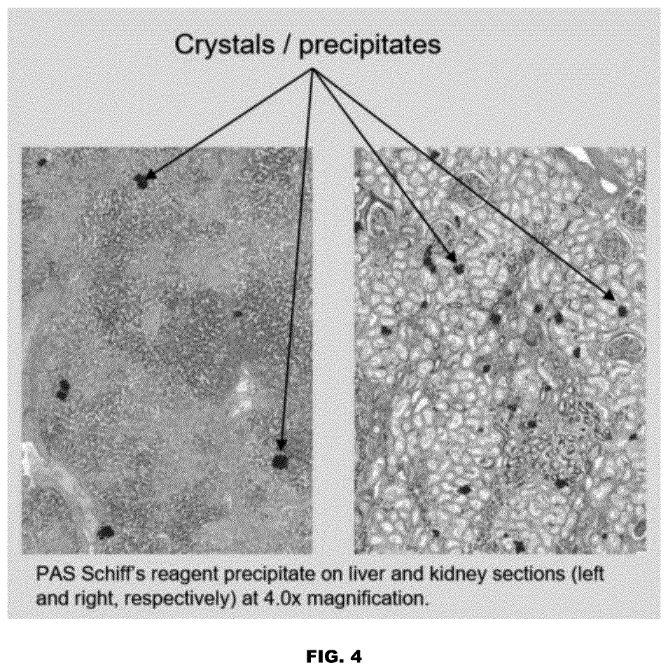

### DETAILED DESCRIPTION

The present disclosure provides compositions, kits, and methods for staining a biological sample, such as a biological sample disposed on a microscope slide. In particular, the present disclosure provides for in situ synthesized Schiff's reagents that facilitate the staining of a biological sample in a manner equivalent to staining using commercially available Schiff's reagents.

### Definitions

It should also be understood that, unless clearly indicated to the contrary, in any methods claimed herein that include more than one step or act, the order of the steps or acts of the method is not necessarily limited to the order in which the steps or acts of the method are recited.

As used herein, the singular terms “a,” “an,” and “the” include plural referents unless context clearly indicates otherwise. Similarly, the word “or” is intended to include “and” unless the context clearly indicates otherwise. The term “includes” is defined inclusively, such that “includes A or B” means including A, B, or A and B.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of” or “exactly one of.” “Consisting essentially of,” when used in the claims, shall have its ordinary meaning as used in the field of patent law.

As used herein, the terms “comprising,” “including,” “having,” and the like are used interchangeably and have the same meaning. Similarly, “comprises,” “includes,” “has,” and the like are used interchangeably and have the same meaning. Specifically, each of the terms is defined consistent with the common United States patent law definition of “comprising” and is therefore interpreted to be an open term meaning “at least the following,” and is also interpreted not to exclude additional features, limitations, aspects, etc. Thus, for example, “a device having components a, b, and c” means that the device includes at least components a, b and c. Similarly, the phrase: “a method involving steps a, b, and c” means that the method includes at least steps a, b, and c. Moreover, while the steps and processes may be outlined herein in a particular order, the skilled artisan will recognize that the ordering steps and processes may vary.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

Reference throughout this specification to “one embodiment” or “an embodiment” means that a particular feature, structure, or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

As used herein, the term “alkyl,” by itself or as part of another substituent, means, unless otherwise stated, a straight (i.e., unbranched) or branched chain, or combination thereof, which may be fully saturated, mono- or polyunsaturated and can include di- and multivalent radicals, having the number of carbon atoms designated (i.e., C₁-C₁₀ means one to ten carbons). An “alkyl” is not cyclized. Examples of saturated hydrocarbon radicals include, but are not limited to, groups such as methyl, ethyl, n-propyl, isopropyl, n-butyl, t-butyl, isobutyl, sec-butyl, (cyclohexyl)methyl, homologs and isomers of, for example, n-pentyl, n-hexyl, n-heptyl, n-octyl, and the like. An unsaturated alkyl group is one having one or more double bonds or triple bonds. Examples of unsaturated alkyl groups include, but are not limited to, vinyl, 2-propenyl, crotyl, 2-isopentenyl, 2-butadienyl, 2,4-pentadienyl, 3-(1,4-pentadienyl), ethynyl, 1- and 3-propynyl, 3-butynyl, and the higher homologs and isomers. An alkoxy is an alkyl attached to the remainder of the molecule via an oxygen atom (—O—).

As used herein, the terms “analog” or “derivative” are used in accordance with its plain ordinary meaning within Chemistry and Biology and refers to a chemical compound that is structurally similar to another compound (i.e., a so-called “reference” compound) but differs in composition, e.g., in the replacement of one atom by an atom of a different element, or in the presence of a particular functional group, or the replacement of one functional group by another functional group, or the absolute stereochemistry of one or more chiral centers of the reference compound. Accordingly, an analog is a compound that is similar or comparable in function and appearance but not in structure or origin to a reference compound.

As used herein, the term “antibody,” occasionally abbreviated “Ab,” refers to immunoglobulins or immunoglobulin-like molecules, including by way of example and without limitation, IgA, IgD, IgE, IgG and IgM, combinations thereof, and similar molecules produced during an immune response in any vertebrate, (e.g., in mammals such as humans, goats, rabbits and mice) and antibody fragments that specifically bind to a molecule of interest (or a group of highly similar molecules of interest) to the substantial exclusion of binding to other molecules. Antibody further refers to a polypeptide ligand comprising at least a light chain or heavy chain immunoglobulin variable region which specifically recognizes and binds an epitope of an antigen. Antibodies may be composed of a heavy and a light chain, each of which has a variable region, termed the variable heavy (VH) region and the variable light (VL) region. Together, the VH region and the VL region are responsible for binding the antigen recognized by the antibody. The term antibody also includes intact immunoglobulins and the variants and portions of them well known in the art.

As used herein, the term “antigen” refers to a compound, composition, or substance that may be specifically bound by the products of specific humoral or cellular immunity, such as an antibody molecule or T-cell receptor. Antigens can be any type of molecule including, for example, haptens, simple intermediary metabolites, sugars (e.g., oligosaccharides), lipids, and hormones as well as macromolecules such as complex carbohydrates (e.g., polysaccharides), phospholipids, nucleic acids and proteins.

As used herein, the term a “biological sample” can be any solid or fluid sample obtained from, excreted by or secreted by any living organism, including without limitation, single celled organisms, such as bacteria, yeast, protozoans, and amoebas among others, multicellular organisms (such as plants or animals, including samples from a healthy or apparently healthy human subject or a human patient affected by a condition or disease to be diagnosed or investigated, such as cancer). For example, a biological sample can be a biological fluid obtained from, for example, blood, plasma, serum, urine, bile, ascites, saliva, cerebrospinal fluid, aqueous or vitreous humor, or any bodily secretion, a transudate, an exudate (for example, fluid obtained from an abscess or any other site of infection or inflammation), or fluid obtained from a joint (for example, a normal joint or a joint affected by disease). A biological sample can also be a sample obtained from any organ or tissue (including a biopsy or autopsy specimen, such as a tumor biopsy) or can include a cell (whether a primary cell or cultured cell) or medium conditioned by any cell, tissue or organ. In some examples, a biological sample is a nuclear extract. In certain examples, a sample is a quality control sample, such as one of the disclosed cell pellet section samples. In other examples, a sample is a test sample. Samples can be prepared using any method known in the art by of one of ordinary skill. The samples can be obtained from a subject for routine screening or from a subject that is suspected of having a disorder, such as a genetic abnormality, infection, or a neoplasia. The described embodiments of the disclosed method can also be applied to samples that do not have genetic abnormalities, diseases, disorders, etc., referred to as “normal” samples. Samples can include multiple targets that can be specifically bound by one or more detection probes.

As used herein, “Cₐ to C_{b}” in which “a” and “b” are integers refer to the number of carbon atoms in an alkyl, alkenyl or alkynyl group, or the number of carbon atoms in the ring of a cycloalkyl, cycloalkenyl, cycloalkynyl or aryl group, or the total number of carbon atoms and heteroatoms in a heteroalkyl, heterocyclyl, heteroaryl or heteroalicyclyl group. That is, the alkyl, alkenyl, alkynyl, ring of the cycloalkyl, ring of the cycloalkenyl, ring of the cycloalkynyl, ring of the aryl, ring of the heteroaryl or ring of the heteroalicyclyl can contain from “a” to “b”, inclusive, carbon atoms. Thus, for example, a “C₁ to C₄ alkyl” group refers to all alkyl groups having from 1 to 4 carbons, that is, CH₃—, CH₃CH₂—, CH₃CH₂CH₂—, (CH₃)₂CH—, CH₃CH₂CH₂CH₂, CH₃CH₂CH(CH₃)— and (CH₃)₃C—. If no “a” and “b” are designated with regard to an alkyl, alkenyl, alkynyl, cycloalkyl cycloalkenyl, cycloalkynyl, aryl, heteroaryl or heteroalicyclyl group, the broadest range described in these definitions is to be assumed.

As used herein, “cycloalkyl” of like terms (e.g., a cyclic alkyl group) refer to a completely saturated (no double or triple bonds) mono- or multi-cyclic hydrocarbon ring system. When composed of two or more rings, the rings may be joined together in a fused fashion. Cycloalkyl groups can contain 3 to 10 atoms in the ring(s) or 3 to 8 atoms in the ring(s). A cycloalkyl group may be unsubstituted or substituted. Typical cycloalkyl groups include, but are in no way limited to, cyclopropyl, cyclobutyl, cyclopentyl, cyclohexyl, cycloheptyl and cyclooctyl.

As used herein, the terms “halogen atom” or “halogen” mean any one of the radio-stable atoms of column 7 of the Periodic Table of the Elements, such as, fluorine, chlorine, bromine and iodine.

As used herein, the term “heteroatom” is meant to include boron (B), oxygen (O), nitrogen (N), sulfur(S), phosphorus (P), and silicon (Si). In some embodiments, a “heterocyclic ring” may comprise one or more heteroatoms. In other embodiments, an aliphatic group may comprise or be substituted by one or more heteroatoms.

As used herein, the terms “reactive group” or “reactive functional group” refer to a functional group that are capable of chemically associating with, interacting with, hybridizing with, hydrogen bonding with, or coupling with a functional group of a different moiety. In some embodiments, a “reaction” between two reactive groups or two reactive functional groups may mean that a covalent linkage is formed between two reactive groups or two reactive functional groups; or may mean that the two reactive groups or two reactive functional groups associate with each other, interact with each other, hybridize to each other, hydrogen bond with each other, etc. In some embodiments, the “reaction” thus includes binding events, such as the binding of a hapten with an anti-hapten antibody, or a guest molecule associating with a supramolecular host molecule.

As used herein, the term “specific binding entity” refers to a member of a specific-binding pair. Specific binding pairs are pairs of molecules that are characterized in that they bind each other to the substantial exclusion of binding to other molecules (for example, specific binding pairs can have a binding constant that is at least 10−3 M greater, 10−4 M greater or 10−5 M greater than a binding constant for either of the two members of the binding pair with other molecules in a biological sample). Particular examples of specific binding moieties include specific binding proteins (for example, antibodies, lectins, avidins such as streptavidins, and protein A). Specific binding moieties can also include the molecules (or portions thereof) that are specifically bound by such specific binding proteins.

As used herein, the terms “stain,” “staining,” or the like as used herein generally refers to any treatment of a biological specimen that detects and/or differentiates the presence, location, and/or amount (such as concentration) of a particular molecule (such as a lipid, protein or nucleic acid) or particular structure (such as a normal or malignant cell, cytosol, nucleus, Golgi apparatus, or cytoskeleton) in the biological specimen. For example, staining can provide contrast between a particular molecule or a particular cellular structure and surrounding portions of a biological specimen, and the intensity of the staining can provide a measure of the amount of a particular molecule in the specimen. Staining can be used to aid in the viewing of molecules, cellular structures, and organisms not only with bright-field microscopes, but also with other viewing tools, such as phase contrast microscopes, electron microscopes, and fluorescence microscopes. Some staining performed by the system 2 can be used to visualize an outline of a cell. Other staining performed by the system 2 may rely on certain cell components (such as molecules or structures) being stained without or with relatively little staining other cell components. Examples of types of staining methods performed by the system 2 include, without limitation, histochemical methods, immunohistochemical methods, and other methods based on reactions between molecules (including non-covalent binding interactions), such as hybridization reactions between nucleic acid molecules. Particular staining methods include, but are not limited to, primary staining methods (e.g., H&E staining, Pap staining, etc.), enzyme-linked immunohistochemical methods, and in situ RNA and DNA hybridization methods, such as fluorescence in situ hybridization (FISH).

Whenever a group or moiety is described as being “substituted” or “optionally substituted” (or “optionally having” or “optionally comprising”) that group may be unsubstituted or substituted with one or more of the indicated substituents. Likewise, when a group is described as being “substituted or unsubstituted” if substituted, the substituent(s) may be selected from one or more the indicated substituents. If no substituents are indicated, it is meant that the indicated “optionally substituted” or “substituted” group may be substituted with one or more group(s) individually and independently selected from alkyl, alkenyl, alkynyl, cycloalkyl, cycloalkenyl, cycloalkynyl, aryl, heteroaryl, heteroalicyclyl, aralkyl, heteroaralkyl, (heteroalicyclyl)alkyl, hydroxy, protected hydroxyl, alkoxy, aryloxy, acyl, mercapto, alkylthio, arylthio, cyano, cyanate, halogen, thiocarbonyl, O-carbamyl, N-carbamyl, O-thiocarbamyl, N-thiocarbamyl, C-amido, N-amido, S-sulfonamido, N-sulfonamido, C-carboxy, protected C-carboxy, O-carboxy, isocyanato, thiocyanato, isothiocyanato, nitro, silyl, sulfenyl, sulfinyl, sulfonyl, haloalkyl, haloalkoxy, trihalomethanesulfonyl, trihalomethanesulfonamido, an amino, ether, amino (e.g. a mono-substituted amino group or a di-substituted amino group), and protected derivatives thereof. Any of the above groups may include one or more heteroatoms, including O, N, or S. For example, where a moiety is substituted with an alkyl group, that alkyl group may comprise a heteroatom selected from O, N, or S (e.g. —(CH₂—CH₂—O—CH₂—CH₂)').

As used herein, “% w/v” refers to a weight/volume percentage concentration, in terms of grams of solute per 100 mL of solution.

As used herein, the terms “about” or “substantially” mean at most +/−10% of the indicated value, e.g., +/−10%, +/−9%, +/−8%, +/−7%, +/−6%, +/−5%, +/−4%, +/−3%, +/−2%, or +/−1% of the indicated value.

### Overview

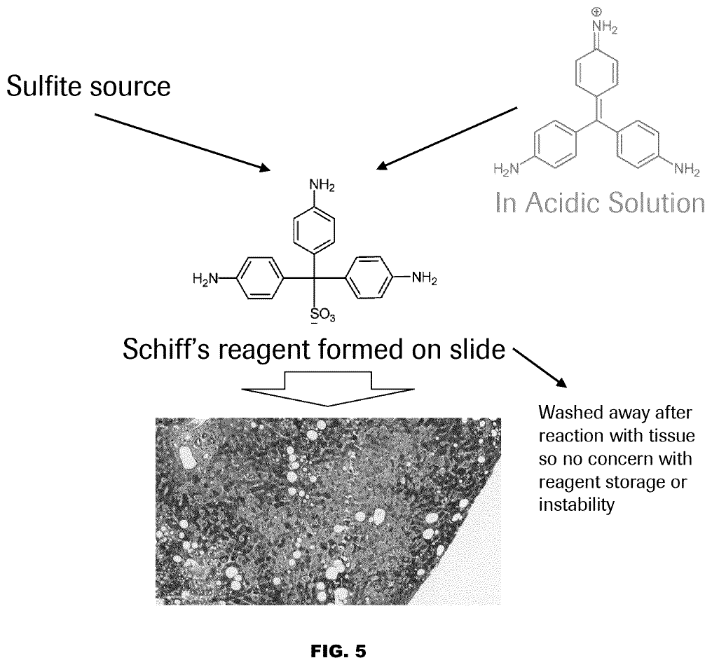

Applicant has developed compositions, kits, and methods used for synthesizing a Schiff's reagent in situ, i.e., directly on a substrate, such as within a puddle disposed on the surface of a substrate, such as on the surface of a biological sample A general method of synthesizing the Schiff's reagent in situ is depicted in FIG. 5. Applicant has also developed methods of a staining a biological sample, such as a biological sample disposed on a substrate, using an in situ synthesized Schiff's reagent.

### Compositions

The present disclosure provides dye compositions and sulfite or SO₂ source composition. Each of these compositions may be dispensed, simultaneously or subsequently, to a biological sample, such as a biological sample disposed on a slide. Moreover, each of these compositions may be included in one or more kits for use with automated staining systems.

### Dye Compositions

In some embodiments, the present disclosure provides for a composition (hereinafter “dye composition”) including one or more dyes having a 4-Benzhydrylidene-2,5-cyclohexadien-1-imine core (herein after “dyes”). In some embodiments, the dye composition includes an optional acid, one or more optional solvents, and optionally one or more additives. In some embodiments, the dye composition includes the one or more dyes, an acid, and optionally one or more additives. In other embodiments, the dye composition includes the one or more dyes, one or more solvents, and optionally one or more additives. In yet other embodiments, the dye composition includes the one or more dyes, an acid, one or more solvents, and optionally one or more additives. In some embodiments, the dye compositions are stable for at least 12 months, at least 18 months, at least 24 months, at least 30 months, at least 36 months, etc. In some embodiments, the dye compositions are free of precipitates for at least 12 months, at least 18 months, at least 24 months, at least 30 months, at least 36 months, etc. In some embodiments, the dye compositions are substantially free of precipitates for at least 12 months, at least 18 months, at least 24 months, at least 30 months, at least 36 months, etc.

In some embodiments, the one or more dyes having the 4-Benzhydrylidene-2,5-cyclohexadien-1-imine core are functionalized to include at least one substituted or unsubstituted amine group. In other embodiments, the one or more dyes having the 4-Benzhydrylidene-2,5-cyclohexadien-1-imine core are functionalized to include at least one substituted or unsubstituted amine group; and further functionalized to include one or more C₁-C₄ alkyl groups. In other embodiments, the one or more dyes having the 4-Benzhydrylidene-2,5-cyclohexadien-1-imine core are functionalized to include at least two substituted or unsubstituted amine groups. In yet other embodiments, the one or more dyes having the 4-Benzhydrylidene-2,5-cyclohexadien-1-imine core are functionalized to include at least two substituted or unsubstituted amine groups; and further functionalized to include one or more C₁-C₄ alkyl groups. In further embodiments, the one or more dyes having the 4-Benzhydrylidene-2,5-cyclohexadien-1-imine core are functionalized to include at least two substituted or unsubstituted amine groups; and further functionalized to include two or more C₁-C₄ alkyl groups. In some embodiments, the at least one substituted amine group is substituted with a C₁-C₄ alkyl group.

In some embodiments, the one or more dyes having the 4-Benzhydrylidene-2,5-cyclohexadien-1-imine core are functionalized to include at least one unsubstituted amine group. In other embodiments, the one or more dyes having the 4-Benzhydrylidene-2,5-cyclohexadien-1-imine core are functionalized to include at least one unsubstituted amine group; and further functionalized to include one or more C₁-C₄ alkyl groups. In other embodiments, the one or more dyes having the 4-Benzhydrylidene-2,5-cyclohexadien-1-imine core are functionalized to include at least two unsubstituted amine groups. In yet other embodiments, the one or more dyes having the 4-Benzhydrylidene-2,5-cyclohexadien-1-imine core are functionalized to include at least two unsubstituted amine groups; and further functionalized to include one or more C₁-C₄ alkyl groups.

In further embodiments, the one or more dyes having the 4-Benzhydrylidene-2,5-cyclohexadien-1-imine core have a molecular weight ranging from between about 300 g/mol to about 600 g/mol, from between about 300 g/mol to about 500 g/mol, from between about 300 g/mol to about 450 g/mol, from between about 300 g/mol to about 400 g/mol, from between about 300 g/mol to about 375 g/mol, from between about 300 g/mol to about 350 g/mol, from between about 310 g/mol to about 340 g/mol, or from between about 310 g/mol to about 330 g/mol.

In some embodiments, the one or more dyes having the 4-Benzhydrylidene-2,5-cyclohexadien-1-imine core have any one of Formulas (I)—(XII):

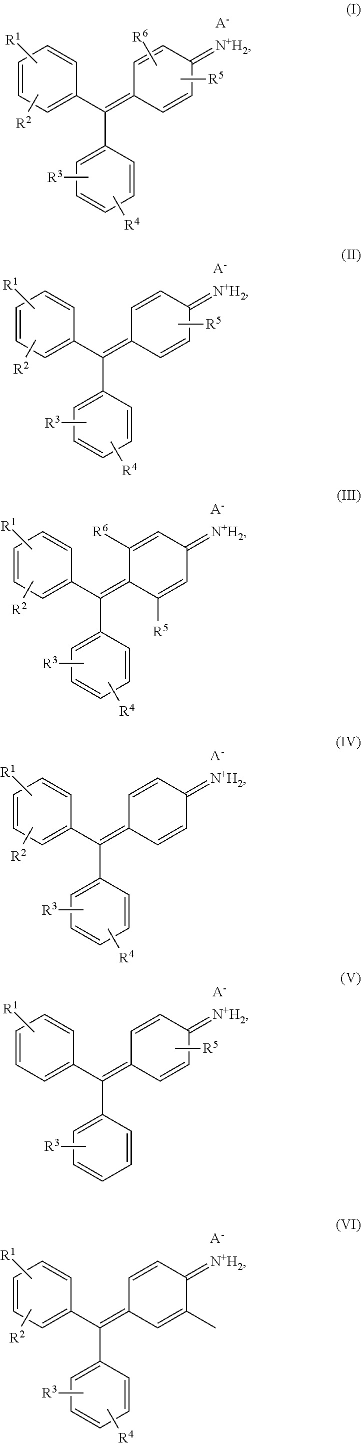

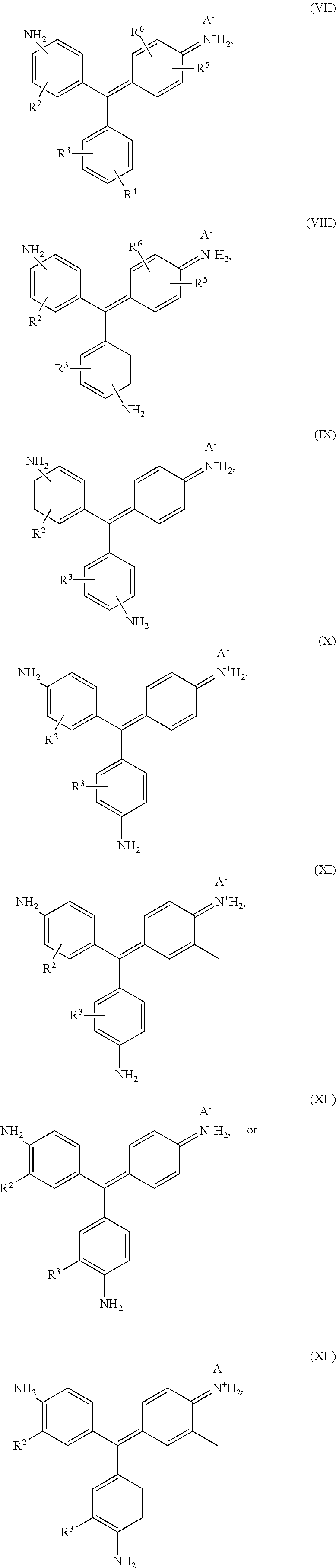

wherein R¹, R², R³, R⁴, R⁵, and R⁶ are independently H, a halogen, a branched or unbranched, substituted or unsubstituted C₁-C₆ alkyl group or cycloalkyl group, —OH, —O—C₁-C₆ alkyl, or —N(R^{x})(R^{y}), where R^{x} and R^{y} are independently H or a branched or unbranched C₁-C₆ alkyl group optionally substituted with one or more halogen atoms, or where either R¹ and R² together, or R³ and R⁴ together, or R⁵ or R⁶ together form a 5- or 6-membered cyclic ring or heterocyclic ring which may be optionally substituted with one or more C₁-C₆ alkyl groups or one or more —N(R^{x})(R^{y}) groups; and where A is a counterion.

In some embodiments, R¹, R², R³, R⁴, R⁵, and R⁶ are independently H, a branched or unbranched, substituted or unsubstituted C₁-C₆ alkyl group or cycloalkyl group, —OH, —O—C₁-C₆ alkyl, or —N(R^{x})(R^{y}), where R^{x} and R^{y} are independently H or a branched or unbranched C₁-C₆ alkyl group. In some embodiments, R¹, R², R³, R⁴, R⁵, and R⁶ are independently H, a branched or unbranched, substituted or unsubstituted C₁-C₆ alkyl group, or —N(R^{x})(R^{y}), where R^{x} and R^{y} are independently H or a C₁-C₂ alkyl group. In some embodiments, R¹, R², R³, R⁴, R⁵, and R⁶ are independently H, a branched or unbranched, substituted or unsubstituted C₁-C₆ alkyl group, or —N(R^{x}) (R^{y}), where R^{x} and R^{y} are independently H or —CH₃. In some embodiments, R¹, R², R³, R⁴, R⁵, and R⁶ are independently H, a branched or unbranched, substituted or unsubstituted C₁-C₆ alkyl group, or —NH₂.

In some embodiments, at least two of R¹, R², R³, R⁴, R⁵, and R⁶ are —N(R^{x})(R^{y}). In some embodiments, at least two of R¹, R², R³, R⁴, R⁵, and R⁶ are —N(R^{x})(R^{y}) and wherein at least another two of R¹, R², R³, R⁴, R⁵, and R⁶ are a branched or unbranched, substituted or unsubstituted C₁-C₆ alkyl group or cycloalkyl group. In some embodiments, at least two of R¹, R², R³, R⁴, R⁵, and R⁶ are —N(R^{x})(R^{y}) and wherein at least another two of R¹, R², R³, R⁴, R⁵, and R⁶ are a branched or unbranched, substituted or unsubstituted C₁-C₄ alkyl group or cycloalkyl group. In some embodiments, at least two of R¹, R², R³, R⁴, R⁵, and R⁶ are —N(R^{x})(R^{y}) and wherein at least another two of R¹, R², R³, R⁴, R⁵, and R⁶ are a branched or unbranched, substituted or unsubstituted C₁-C₃ alkyl group or cycloalkyl group. In some embodiments, at least two of R¹, R², R³, R⁴, R⁵, and R⁶ are —N(R^{x})(R^{y}) and wherein at least another two of R¹, R², R³, R⁴, R⁵, and R⁶ are a C₁-C₂ alkyl group.

In some embodiments, at least two of R¹, R², R³, R⁴, R⁵, and R⁶ are —N(R^{x})(R^{y}) and wherein at least another two of R¹, R², R³, R⁴, R⁵, and R⁶ are a branched or unbranched, substituted or unsubstituted C₁-C₆ alkyl group or cycloalkyl group; and wherein at least one of R^{x} or R^{y} is H. In some embodiments, at least two of R¹, R², R³, R⁴, R⁵, and R⁶ are —N(R^{x})(R^{y}) and wherein at least another two of R¹, R², R³, R⁴, R⁵, and R⁶ are a branched or unbranched, substituted or unsubstituted C₁-C₄ alkyl group or cycloalkyl group; and wherein at least one of R^{x} or R^{y} is H. In some embodiments, at least two of R¹, R², R³, R⁴, R⁵, and R⁶ are —N(R^{x})(R^{y}) and wherein at least another two of R¹, R², R³, R⁴, R⁵, and R⁶ are a branched or unbranched, substituted or unsubstituted C₁-C₃ alkyl group or cycloalkyl group; and wherein at least one of R^{x} or R^{y} is H. In some embodiments, at least two of R¹, R², R³, R⁴, R⁵, and R⁶ are —N(R^{x})(R^{y}) and wherein at least another two of R¹, R², R³, R⁴, R⁵, and R⁶ are C₁-C₂ alkyl group; and wherein at least one of R^{x} or R^{y} is H.

In some embodiments, at least two of R¹, R², R³, R⁴, R⁵, and R⁶ are —NH₂ and wherein at least another two of R¹, R², R³, R⁴, R⁵, and R⁶ are a branched or unbranched, substituted or unsubstituted C₁-C₆ alkyl group or cycloalkyl group. In some embodiments, at least two of R¹, R², R³, R⁴, R⁵, and R⁶ are —NH₂ and wherein at least another two of R¹, R², R³, R⁴, R⁵, and R⁶ are a branched or unbranched, substituted or unsubstituted C₁-C₄ alkyl group or cycloalkyl group. In some embodiments, at least two of R¹, R², R³, R⁴, R⁵, and R⁶ are —NH₂ and wherein at least another two of R¹, R², R³, R⁴, R⁵, and R⁶ are a branched or unbranched, substituted or unsubstituted C₁-C₃ alkyl group or cycloalkyl group. In some embodiments, at least two of R¹, R², R³, R⁴, R⁵, and R⁶ are —NH₂ and wherein at least another two of R¹, R², R³, R⁴, R⁵, and R⁶ are a C₁-C₂ alkyl group.

In some embodiments, the compounds having Formulas (I)—(III) have molecular weight ranging from between about 300 g/mol to about 600 g/mol; between about 300 g/mol to about 550 g/mol; between about 300 g/mol to about 525 g/mol; between about 300 g/mol to about 500 g/mol; between about 300 g/mol to about 475 g/mol; between about 300 g/mol to about 450 g/mol; between about 300 g/mol to about 425 g/mol; between about 300 g/mol to about 400 g/mol; between about 300 g/mol to about 390 g/mol; between about 300 g/mol to about 380 g/mol; between about 300 g/mol to about 370 g/mol; between about 300 g/mol to about 360 g/mol; between about 300 g/mol to about 365 g/mol; between about 300 g/mol to about 350 g/mol; between about 300 g/mol to about 345 g/mol; between about 300 g/mol to about 340 g/mol; between about 300 g/mol to about 335 g/mol; and between about 300 g/mol to about 330 g/mol.

In some embodiments, at least two of R¹, R², R³, R⁴, R⁵, and R⁶ are —N(R^{x})(R^{y}) and wherein at least another two of R¹, R², R³, R⁴, R⁵, and R⁶ are a branched or unbranched, substituted or unsubstituted C₁-C₆ alkyl group or cycloalkyl group; and wherein at least one of R^{x} or R^{y} is H, and which have a molecular weight ranging from between about 300 g/mol to about 450 g/mol. In some embodiments, at least two of R¹, R², R³, R⁴, R⁵, and R⁶ are —N(R^{x})(R^{y}) and wherein at least another two of R¹, R², R³, R⁴, R⁵, and R⁶ are a branched or unbranched, substituted or unsubstituted C₁-C₄ alkyl group or cycloalkyl group; and wherein at least one of R^{x} or R^{y} is H, and which have a molecular weight ranging from between about 300 g/mol to about 450 g/mol. In some embodiments, at least two of R¹, R², R³, R⁴, R⁵, and R⁶ are —N(R^{x})(R^{y}) and wherein at least another two of R¹, R², R³, R⁴, R⁵, and R⁶ are a branched or unbranched, substituted or unsubstituted C₁-C₃ alkyl group or cycloalkyl group; and wherein at least one of R^{x} or R^{y} is H, and which have a molecular weight ranging from between about 300 g/mol to about 450 g/mol. In some embodiments, at least two of R¹, R², R³, R⁴, R⁵, and R⁶ are —N(R^{x})(R^{y}) and wherein at least another two of R¹, R², R³, R⁴, R⁵, and R⁶ are C₁-C₂ alkyl group; and wherein at least one of R^{x} or R^{y} is H, and which have a molecular weight ranging from between about 300 g/mol to about 450 g/mol.

In some embodiments, at least two of R¹, R², R³, R⁴, R⁵, and R⁶ are —NH₂ and wherein at least another two of R¹, R², R³, R⁴, R⁵, and R⁶ are a branched or unbranched, substituted or unsubstituted C₁-C₆ alkyl group or cycloalkyl group, and which have a molecular weight ranging from between about 300 g/mol to about 450 g/mol. In some embodiments, at least two of R¹, R², R³, R⁴, R⁵, and R⁶ are —NH₂ and wherein at least another two of R¹, R², R³, R⁴, R⁵, and R⁶ are a branched or unbranched, substituted or unsubstituted C₁-C₆ alkyl group or cycloalkyl group, and which have a molecular weight ranging from between about 300 g/mol to about 400 g/mol. In some embodiments, at least two of R¹, R², R³, R⁴, R⁵, and R⁶ are —NH₂ and wherein at least another two of R¹, R², R³, R⁴, R⁵, and R⁶ are a branched or unbranched, substituted or unsubstituted C₁-C₆ alkyl group or cycloalkyl group, and which have a molecular weight ranging from between about 300 g/mol to about 350 g/mol.

In some embodiments, at least two of R¹, R², R³, R⁴, R⁵, and R⁶ are —NH₂ and wherein at least another two of R¹, R², R³, R⁴, R⁵, and R⁶ are a branched or unbranched, substituted or unsubstituted C₁-C₄ alkyl group or cycloalkyl group, and which have a molecular weight ranging from between about 300 g/mol to about 450 g/mol. In some embodiments, at least two of R¹, R², R³, R⁴, R⁵, and R⁶ are —NH₂ and wherein at least another two of R¹, R², R³, R⁴, R⁵, and R⁶ are a branched or unbranched, substituted or unsubstituted C₁-C₄ alkyl group or cycloalkyl group, and which have a molecular weight ranging from between about 300 g/mol to about 400 g/mol. In some embodiments, at least two of R¹, R², R³, R⁴, R⁵, and R⁶ are —NH₂ and wherein at least another two of R¹, R², R³, R⁴, R⁵, and R⁶ are a branched or unbranched, substituted or unsubstituted C₁-C₄ alkyl group or cycloalkyl group, and which have a molecular weight ranging from between about 300 g/mol to about 350 g/mol.

In some embodiments, at least two of R¹, R², R³, R⁴, R⁵, and R⁶ are —NH₂ and wherein at least another two of R¹, R², R³, R⁴, R⁵, and R⁶ are a branched or unbranched, substituted or unsubstituted C₁-C₃ alkyl group or cycloalkyl group, and which have a molecular weight ranging from between about 300 g/mol to about 450 g/mol. In some embodiments, at least two of R¹, R², R³, R⁴, R⁵, and R⁶ are —NH₂ and wherein at least another two of R¹, R², R³, R⁴, R⁵, and R⁶ are a branched or unbranched, substituted or unsubstituted C₁-C₃ alkyl group or cycloalkyl group, and which have a molecular weight ranging from between about 300 g/mol to about 400 g/mol. In some embodiments, at least two of R¹, R², R³, R⁴, R⁵, and R⁶ are —NH₂ and wherein at least another two of R¹, R², R³, R⁴, R⁵, and R⁶ are a branched or unbranched, substituted or unsubstituted C₁-C₃ alkyl group or cycloalkyl group, and which have a molecular weight ranging from between about 300 g/mol to about 350 g/mol.

In some embodiments, at least two of R¹, R², R³, R⁴, R⁵, and R⁶ are —NH₂ and wherein at least another two of R¹, R², R³, R⁴, R⁵, and R⁶ are a C₁-C₂ alkyl group, and which have a molecular weight ranging from between about 300 g/mol to about 450 g/mol. In some embodiments, at least two of R¹, R², R³, R⁴, R⁵, and R⁶ are —NH₂ and wherein at least another two of R¹, R², R³, R⁴, R⁵, and R⁶ are a C₁-C₂ alkyl group, and which have a molecular weight ranging from between about 300 g/mol to about 400 g/mol. In some embodiments, at least two of R¹, R², R³, R⁴, R⁵, and R⁶ are —NH₂ and wherein at least another two of R¹, R², R³, R⁴, R⁵, and R⁶ are a C₁-C₂ alkyl group, and which have a molecular weight ranging from between about 300 g/mol to about 350 g/mol.

In some embodiments, the dye is selected from:

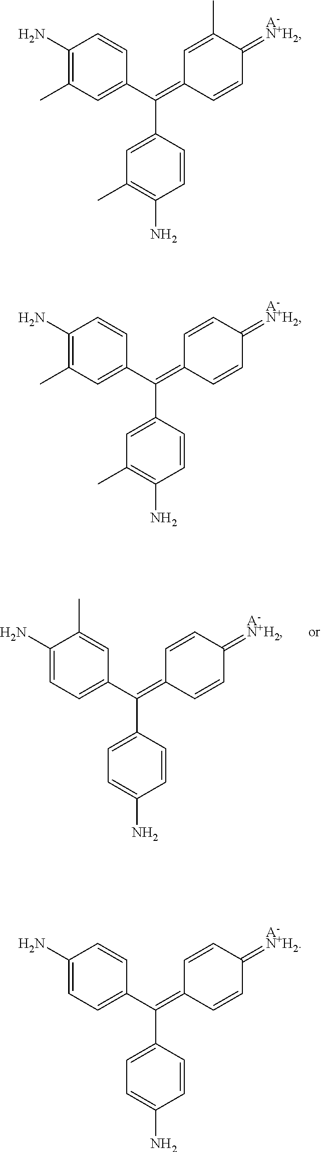

In some embodiments, a total concentration of the one or more dyes having the 4-Benzhydrylidene-2,5-cyclohexadien-1-imine core (including any of the dyes having any one of Formulas (I) to (XII)) within the dye composition ranges from between about 0.05% w/v to about 8% w/v; from between about 0.1% w/v to about 6% w/v; from between about 0.1% w/v to about 5% w/v; from between about 0.1% w/v to about 4% w/v; from between about 0.1% w/v to about 3.5% w/v; from between about 0.1% w/v to about 3% w/v; from between about 0.1% w/v to about 2.5% w/v; from between about 0.1% w/v to about 2% w/v; from between about 0.1% w/v to about 1.5% w/v; from between about 0.1% w/v to about 1% w/v; from between about 0.15% w/v to about 4% w/v; from between about 0.15% w/v to about 3.5% w/v; from between about 0.15% w/v to about 3% w/v; from between about 0.15% w/v to about 2.5% w/v; from between about 0.15% w/v to about 2% w/v; from between about 0.15% w/v to about 1.5% w/v; from between about 0.15% w/v to about 1% w/v; from between about 0.2% w/v to about 4%; from between about 0.2% w/v to about 3.5%; from between about 0.2% w/v to about 3%; from between about 0.2% w/v to about 2.5%; from between about 0.2% w/v to about 2% w/v; from between about 0.2% w/v to about 1.5% w/v; from between about 0.2% w/v to about 1% w/v; from between about 0.25% w/v to about 4%; from between about 0.25% w/v to about 3.5%; from between about 0.25% w/v to about 3%; from between about 0.25% w/v to about 2.5%; from between about 0.25% w/v to about 2% w/v; from between about 0.25% w/v to about 1.5% w/v; from between about 0.25% w/v to about 1% w/v; from between about 0.3% w/v to about 4%; from between about 0.3% w/v to about 3.5%; from between about 0.3% w/v to about 3%; from between about 0.3% w/v to about 2.5%; from between about 0.3% w/v to about 2% w/v; from between about 0.3% w/v to about 1.5% w/v; from between about 0.3% w/v to about 1% w/v; from between about 0.4% w/v to about 4%; from between about 0.4% w/v to about 3.5%; from between about 0.4% w/v to about 3%; from between about 0.4% w/v to about 2.5%; from between about 0.4% w/v to about 2% w/v; from between about 0.4% w/v to about 1.5% w/v; from between about 0.4% w/v to about 1% w/v; from between about 0.5% w/v to about 4%; from between about 0.5% w/v to about 3.5%; from between about 0.5% w/v to about 3%; from between about 0.5% w/v to about 2.5%; from between about 0.5% w/v to about 2% w/v; from between about 0.5% w/v to about 1.5% w/v; from between about 0.5% w/v to about 1% w/v; from between about 0.6% w/v to about 4%; from between about 0.6% w/v to about 3.5%; from between about 0.6% w/v to about 3%; from between about 0.6% w/v to about 2.5%; from between about 0.6% w/v to about 2% w/v; from between about 0.6% w/v to about 1.5% w/v; from between about 0.6% w/v to about 1% w/v; from between about 0.8% w/v to about 4%; from between about 0.8% w/v to about 3.5%; from between about 0.8% w/v to about 3%; from between about 0.8% w/v to about 2.5%; from between about 0.8% w/v to about 2%; from between about 0.8% w/v to about 2%; from between about 1% w/v to about 4%; from between about 1% w/v to about 3.5%; from between about 1% w/v to about 3%; from between about 1% w/v to about 2.5%; from between about 1% w/v to about 2%; from between about 1.5% w/v to about 4%; from between about 1.5% w/v to about 3.5%; from between about 1.5% w/v to about 3%; from between about 1.5% w/v to about 2.5%; from between about 1.5% w/v to about 2%; from between about 2% w/v to about 4%; from between about 2% w/v to about 3.5%; from between about 2% w/v to about 3%; from between about 2% w/v to about 2.5%; from between about 2.5% w/v to about 4%; from between about 2.5% w/v to about 3.5%; or from between about 2.5% w/v to about 3%.

In some embodiments, the total concentration of the one or more dyes is about 0.1% w/v, about 0.2% w/v, about 0.3% w/v, about 0.4% w/v, about 0.5% w/v, about 0.6% w/v, about 0.7% w/v, about 0.8% w/v, about 0.9% w/v, about 1% w/v, about 1.2% w/v, about 1.4% w/v, about 1.6% w/v, about 1.8% w/v, about 2% w/v, about 2.2% w/v, about 2.4% w/v, about 2.6% w/v, about 2.8% w/v, about 3% w/v, about 3.2% w/v, about 3.4% w/v, about 3.6% w/v, about 3.8% w/v, or about 4% w/v.

In some embodiments, the one or more dyes have a molecular weight ranging from between about 300 g/mol and about 375 g/mol, and wherein the total concentration of the one or more dyes ranges from between about 0.15% w/v to about 1.8% w/v. In other embodiments, the one or more dyes have a molecular weight ranging from between about 300 g/mol and about 350 g/mol, and wherein the total concentration of the one or more dyes ranges from between about 0.3% w/v to about 1.2% w/v.

In some embodiments, the one or more dyes are selected from:

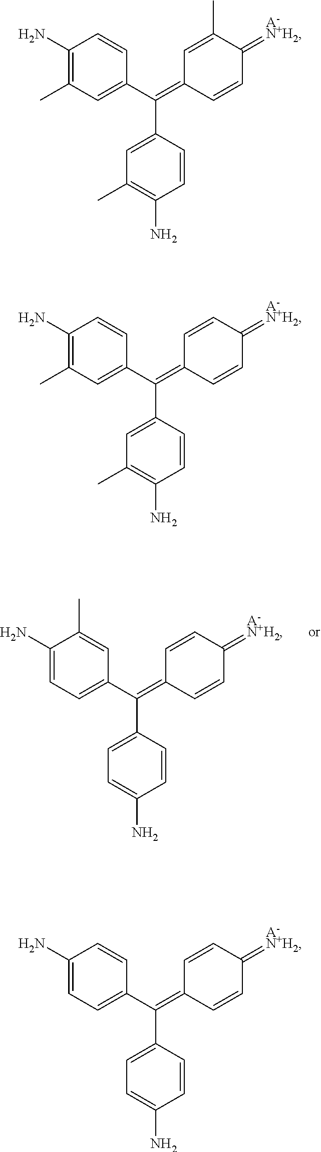

and wherein the total concentration of the one or more dyes ranges from between about 0.15% w/v to about 1.8% w/v, such as from between about 0.3% w/v to about 1.2% w/v.

### Acids

In some embodiments, the dye compositions include an acid. In some embodiments, the acid is a strong acid. In some embodiments, the strong acid is selected from the group consisting of hydrochloric acid, hydrobromic acid, hydrofluoric, trifluoracetic, hydroiodic acid, sulfuric acid, nitric acid, chloric acid, and perchloric acid. In some embodiments, the strong acid has a concentration ranging from between about 0.8M to about 2M. In other embodiments, the strong acid has a concentration ranging from between about 0.9M to about 1.8M. In yet other embodiments, the strong acid has a concentration ranging from between about 1M to about 1.5M. In some embodiments, the strong acid has a concentration at or above about 1M, e.g., about 0.9M, about 0.95M, about 1.0M, about 1.05M, about 1.1M, about 1.15M, about 1.2M, about 1.25M, about 1.3M, about 1.35M, about 1.4M, about 1.45M, about 1.5M, about 1.55M, about 1.6M, about 1.65M, etc. In some embodiments, the strong acid is hydrochloric acid, e.g., 1.2M hydrochloric acid. In some embodiments, the strong acid is nitric acid, e.g., 1.25M nitric acid.

In some embodiments, the acid is a weak acid. In some embodiments, the weak acid is formic acid, acetic acid, benzoic acid, oxalic acid, hydrofluoric acid, nitrous acid, sulfurous acid, and phosphoric acid.

In some embodiments, the pH of the dye composition ranges from between about-0.5 to about 6.5. In other embodiments, the pH ranges from between about −0.5 to about 6. In other embodiments, the pH ranges from between about −0.5 to about 5.5. In other embodiments, the pH ranges from between about −0.5 to about 5. In other embodiments, the pH ranges from between about −0.5 to about 4.5. In other embodiments, the pH ranges from between about −0.5 to about 4. In other embodiments, the pH ranges from between about −0.5 to about 3.5. In other embodiments, the pH ranges from between about −0.5 to about 3. In other embodiments, the pH ranges from between about −0.5 to about 2.5. In other embodiments, the pH ranges from between about −0.5 to about 2.

### Solvents

In some embodiments, the dye composition includes one or more solvents. In some embodiments, the solvent is an alcohol. In some embodiments, the solvent is a polyol.

Non-limiting examples of suitable solvents include, but are not limited to, methanol, ethanol, propanol, butanol, amyl alcohol, pentanol, fusel oil, hexanol, heptanol, octanol, cyclohexanol, benzyl alcohol, furfuryl alcohol, tetrahydrofurfuryl alcohol, hexane, heptane, octane, decane, petroleum ether, petroleum benzine, ligroin, gasoline, kerosene, cyclohexane, benzene, toluene, xylene, tetralin, decalin, terpene oil, chloroform, carbon tetrachloride, ethylene chloride, ethylidene chloride, trichloroethane, tetrachloroethane, trichloroethylene, tetrachloroethylene, trichloropropane, isopropyl chloride, dichloropropane, butyl chloride, amyl chloride, hexyl chloride, ethylene bromide, tetrabromoethane, chlorobenzene, dichlorobenzene, trichlorobenzene, bromobenzene, chlorotoluene, isopropylether, dibutyl ether, diisoamyl ether, hexyl ether, methylphenyl ether, ethylphenyl ether, butylphenyl ether, ethylbenzyl ether, dioxane, 2-methylfuran, tetrahydrofuran, tetrahydropyran, cineole, acetone, methyl ethyl ketone, methyl propyl ketone, methyl butyl ketone, methyl amyl ketone, methyl hexyl ketone, diethyl ketone, ethyl butyl ketone, dipropyl ketone, diisobutyl ketone, diacetone alcohol, phorone, isophorone, cyclohexanone, methyl cyclohexanone, acetophenone, ethyl formate, propyl formate, butyl formate, amyl formate, methyl acetate, ethyl acetate, propyl acetate, butyl acetate, amyl acetate, methyl isoamyl acetate, methoxybutyl acetate, hexyl acetate, cyclohexyl acetate, benzyl acetate, methyl propionate, ethyl propionate, butyl propionate, amyl propionate, methyl butyrate, ethyl butyrate, butyl butyrate, amyl butyrate, methyl acetoacetate, ethyl acetoacetate, isoamyl isovalerate, methyl lactate, ethyl lactate, butyl lactate, amyl lactate, methyl benzoate, diethyl oxalate, ethylene glycol, ethylene glycol monomethyl ether, ethylene glycol monomethyl ether acetate, ethylene glycol monoethyl ether, ethylene glycol diethyl ether, ethylene glycol monoethyl ether acetate, ethylene glycol isopropyl ether, ethylene glycol monobutyl ether, ethylene glycol dibutyl ether, ethylene glycol monobutyl ether acetate, ethylene glycol monophenyl ether, methoxymethoxyethanol, ethylene glycol monoacetate, ethylene glycol diacetate, diethylene glycol, diethylene glycol monomethyl ether, diethylene glycol monoethyl ether, diethylene glycol monoethyl ether acetate, diethylene glycol monobutyl ether, diethylene glycol monobutyl ether acetate, diethylene glycol dimethyl ether, diethylene glycol diethyl ether, diethylene glycol acetate, propylene glycol, propylene glycol monoethyl ether, propylene glycol propyl ether, propylene glycol monobutyl ether, dipropylene glycol, dipropylene glycol monomethyl ether, dipropylene glycol monoethyl ether, trimethylene glycol, butanediol, hexylene glycol, formic acid, acetic acid, acetic anhydride, propionic acid, propionic anhydride, butyric acid, valeric acid, lactic acid, pyridine, picoline, quinoline, isoquinoline, dimethyl sulfoxide, triethyl phosphate, dimethylformamide, γ-butyrolactone, γ-valerolactone, 6-hexanolactone, methyl salicylate, ethyl salicylate, butyl salicylate, diethyl adipate, ethyl carbonate, butyl sulfide, and diacetone alcohol. In some embodiments, the solvent is DMSO.

### Additives

In some embodiments, the dye compositions include one or more additives, e.g., antioxidants, stabilizers, and/or biocides.

The term “antioxidant” is used herein includes any compound or combination of compounds that prevent, or slow down oxidation of components caused by the damaging reactive oxygen species (ROS). Any of the known antioxidants may be used, including but not limited to tocopherols, phospholipids (PL), phytosterols, phycocyanin, vitamins E, A and C, betacarotene, coenzyme Q10, fatty acids omega-3, omega-6 and w-9, phytoantioxidants such as polyphenols, terpenes as butylated hydroxyanisole (BHA), butylated hydroxytoluene (BHT), propyl gallate, lecithin, sesamin, sesamol, sesamolin, α-tocopherol, γ-tocopherol, salicylic acid, ascorbic acid, ascorbyl palmitate, fumaric acid, malic acid, sodium ascorbate and sodium meta-bisulphite, as well as chelating agents such as disodium EDTA. Pharmaceutically acceptable nutraceutical dietary supplements may also be employed as antioxidants including plants, alga, and lichen and may include one or more extracts of honeybee propolis, red clover, soybean, caper, almond, milk thistle, green tea, pomegranate, orange red, grape seed, bilberry, fo-ti root, ginseng, English ivy, red algae, brown algae, green algae and lichens.

In some embodiments, the antioxidant is selected from the group consisting of ascorbic acid and its salts, tocopherols, butylated hydroxyanisole, butylated hydroxytoluene, ascorbyl palmitate, and propyl gallate.

In other embodiments, the antioxidant is selected from the group consisting of ascorbic acid, thioglycerol, thiosorbitol, thiocarbamide, sodium thiosulphate, thioacetic acid, cysteine, methionine, butylated hydroxytoluene (BHT), butylated hydroxyanisole (BHA), ascorbyl palmitate, hydroquinone, propyl gallate, nordihyroguaiaretic acid, Vitamin E (alpha-tocopherol) and lecithin. The preferred antioxidants are micronized propyl gallate, micronized BHA, micronized BHT, Vitamin E, ascorbic acid, sodium thiosulphate, and cysteine.

In yet other embodiments, the antioxidant is selected from the group consisting of hydroquinones; n-alkyl gallates (such as n-propyl, n-octyl, and n-dodecyl gallates); reducible sugars such as sorbitol and mannitol; benzoates and hydroxybenzoates; certain acids such as citric acid, tartaric acid, lactic acid, erythorbic acid ascorbic acid, uric acid, tannic acid, and salts of such acids (such as Mg2+, NH4+, Na+, K+ and Ca2+ salts); chelators such as EDTA that remove metals that function as oxidants.

In yet even further embodiments, the antioxidant is an oil-based antioxidant which selected from the group consisting of ascorbyl palmitate, butylated hydroxytoluene (BHT); butylated hydroxyanisole (BHA); propyl gallate; and alpha-tocopherol.

In a preferred embodiment, the antioxidant is ascorbic acid.

In some embodiments, the composition includes a stabilizer. In other embodiments, the composition includes a biocide or a preservative, a preservative, such as an antibacterial agent. Suitable preservatives include, for example, isothiazolinones, glycols, azides, and combinations thereof. Exemplary preservatives include ProClin® 300 (2.30% 5-chloro-2-methyl-4-isothiazolin-3-one, 0.70% 2-methyl-4-isothiazolin-3-one, 2-3% alkyl carboxylate (a stabilizer), and 93-95% modified glycol; available from Sigma-Aldrich, St. Louis, Mo.), ProClin® 950 (9.5-9.9% 2-methyl-4-isothiazolin-3-one, Sigma-Aldrich), and sodium azide.

### Sulfite or SO₂ Source Composition

The present disclosure also provides compositions including a sulfite or SO₂ source (hereinafter “sulfite or SO₂ source composition”). In some embodiments, the sulfite or SO₂ source composition includes a sulfite or SO₂ source, an optional acid, and one or more optional additives. In some embodiments, the sulfite or SO₂ source is selected from metabisulfite, bisulfite, dithionite, thiosulfate, sulfites, and sulfurous acid. In some embodiments, the sulfite or SO₂ source compositions are stable for at least 12 months, at least 18 months, at least 24 months, at least 30 months, at least 36 months, etc.

In some embodiments, the total concentration of the sulfite or SO₂ source in the sulfite or SO₂ source composition ranges from between about 0.1% w/v to about 21.5% w/v, from between about 0.1% w/v to about 18% w/v, from between about 0.1% w/v to about 12% w/v, from between about 0.1% w/v to about 10% w/v, from between about 0.1% w/v to about 9% w/v, from between about 0.1% w/v to about 8% w/v, from between about 0.1% w/v to about 7% w/v, from between about 0.1% w/v to about 6% w/v, from between about 0.1% w/v to about 5% w/v, from between about 0.1% w/v to about 4% w/v, from between about 0.1% w/v to about 3% w/v, from between about 0.1% w/v to about 2% w/v, from between about 0.1% w/v to about 1% w/v, from between about 0.1% w/v to about 0.5% w/v, from between about 0.1% w/v to about 0.3% w/v, from between about 0.5% w/v to about 21.5% w/v, from between about 0.5% w/v to about 18% w/v, from between about 0.5% w/v to about 12% w/v, from between about 0.5% w/v to about 10% w/v, from between about 0.5% w/v to about 9% w/v, from between about 0.5% w/v to about 8% w/v, from between about 0.5% w/v to about 7% w/v, from between about 0.5% w/v to about 6% w/v, from between about 0.5% w/v to about 5% w/v, from between about 0.5% w/v to about 4% w/v, from between about 0.5% w/v to about 3% w/v, from between about 0.5% w/v to about 2% w/v, from between about 0.5% w/v to about 1% w/v, from between about 1% w/v to about 21.5% w/v, from between about 1% w/v to about 18% w/v, from between about 1% w/v to about 12% w/v, from between about 1% w/v to about 10% w/v, from between about 1% w/v to about 9% w/v, from between about 1% w/v to about 8% w/v, from between about 1% w/v to about 7% w/v, from between about 1% w/v to about 6% w/v, from between about 1% w/v to about 5% w/v, from between about 1% w/v to about 4% w/v, from between about 1% w/v to about 3% w/v, from between about 2.5% w/v to about 21.5% w/v, from between about 2.5% w/v to about 18% w/v, from between about 2.5% w/v to about 12% w/v, from between about 2.5% w/v to about 10% w/v, from between about 2.5% w/v to about 9% w/v, from between about 2.5% w/v to about 8% w/v, from between about 2.5% w/v to about 7% w/v, from between about 2.5% w/v to about 6% w/v, from between about 2.5% w/v to about 5% w/v, from between about 5% w/v to about 21.5% w/v, from between about 5% w/v to about 18% w/v, from between about 5% w/v to about 12% w/v, from between about 5% w/v to about 10% w/v, from between about 5% w/v to about 9% w/v, or from between about 5% w/v to about 8% w/v.

In those embodiments where the source of the sulfite or SO₂ source is not thiosulfate, the sulfite or SO₂ source composition may include an acid (including any those enumerated herein) and/or have a pH of less than about 9, such as less than about 8.5, such as less than about 8, such as less than about 7.5, such as less than about 7. In some embodiments, the pH of the sulfite or SO₂ source composition is between about 5 and 6.9. In some embodiments, the pH of the sulfite or SO₂ source composition is between about 5 and 6.5. In some embodiments, the pH of the sulfite or SO₂ source composition is between about 5.5 and 6.5.

In those embodiments where the sulfite or SO₂ source is thiosulfate, the sulfite or SO₂ source composition has a pH of greater than 7, such as greater than 7.5, such as greater than 8, such as greater than 8.5, or such as greater than 9. In some embodiments, here the sulfite or SO₂ source is thiosulfate, the sulfite or SO₂ source composition has a pH of about 10.

In some embodiments, the sulfite or SO₂ source composition comprises an antioxidant, including any of those enumerated herein. In some embodiments, the sulfite or SO₂ source composition includes a solvent, including any of those enumerated herein. In some embodiments, the sulfite or SO₂ source composition includes an alcohol or a glycol.

### Kits

In some embodiments, the present disclosure provides for a kit including at least two reservoirs, containers, and/or dispensers (referred to collectively as “containers” herein) wherein a first container includes a dye composition, and wherein the second container includes a sulfite or SO₂ source composition. In some embodiments, the kit includes two containers, namely a dye composition which includes an acid, such as any of a weak acid, a strong acid, an inorganic acid, or an organic acid; and a sulfite or SO₂ source composition.

In other embodiments, the kit includes three containers, namely a dye composition which is free from acid, a sulfite or SO₂ source composition; and an acid composition. In some embodiments, the acid composition includes as any of a weak acid, a strong acid, an inorganic acid, or an organic acid, including any of those weak acids, strong acids, inorganic acids, or organic acids described herein.

### Methods of Staining Samples

The present disclosure also provides for methods of forming a Schiff's reagent in situ, such as directly on the surface of a substrate (e.g., a slide), a sample disposed on the substrate, or within a puddle disposed on the substrate. In general, the method comprises applying or dispensing the dye compositions, the sulfite or SO₂ source compositions, and/or the acid compositions to the substrate and allowing the various components of the compositions to react for a predetermined amount of time and at a predetermine temperature. Subsequently, the Schiff's reagent formed in situ may be removed from the substrate, such as by washing the substrate with a wash reagent or a buffer. As noted herein, Appellant has unexpectedly discovered that staining a sample using a Schiff's reagent generated in situ provides for a staining quality and/or intensity at least equivalent to using a commercial Schiff's reagent. Moreover, Appellant has unexpectedly discovered that staining intensity may be “dialed-in” by varying the amount of time any of the reagents are in contact with the sample; varying the temperature of the sample and/or the reagents placed in contact with sample same; and/or varying the concentration of any of the reagents or components of the reagents (e.g., the concentration of the dye, the concentration of the sulfite source, and/or the concentration of the acid).

As used herein, the phrase “dispensed to a substrate means” dispensing a fluid or composition to the surface of a substrate, such as a microscope slide, to a sample disposed on the substrate, or to a puddle disposed on the substrate and/or sample. In some embodiments, the fluid or composition may be dispensed directly to a sample disposed on the substrate. Alternatively, the fluid or composition may be dispensed adjacent to a sample disposed on the substrate, and the dispensed fluid or composition may be subsequently moved to the sample, such as by tilting the substrate and/or using a jet of gas to propel the fluid or composition from the surface of the substrate to the sample. In another embodiment, the fluid or composition may be dispensed to a fluid or reagent “puddle” existing on the surface of the substrate or the sample. The skilled artisan will appreciate that subsequent dispensing of different compositions to the same substrate and/or sample disposed on the substrate may be to the same or approximately the same location, such that any subsequently dispensed fluid or composition comes into contact with an existing fluid puddle such that the fluids and/or compositions may mix and or react.

In some embodiments, the dye compositions, the sulfite or SO₂ source compositions, and/or the acid compositions may be applied to a sample using a manual process. In other embodiments, the dye compositions, the sulfite or SO₂ source compositions, and/or the acid compositions described herein are applied or dispensed to a biological sample, such as within an automated staining apparatus. Non-limiting examples of suitable automated staining systems are described herein.

In some embodiments, and prior to dispensing any of the dye composition, the sulfite or SO₂ source composition, and/or the optional acid composition, the sample is treated with a reagent that forms aldehyde groups for a predetermined amount of time. In some embodiments, and prior to dispensing any of the dye composition, the sulfite or SO₂ source composition, and/or the optional acid composition, the sample is treated with periodic acid (e.g., 1 gram of periodic acid in 100 ml of water) for a time period of about 1 to about 10 minutes (e.g., 5 minutes). In some embodiments, the periodic acid is dispensed to the sample and allowed to remain in contact with the sample for a predetermined about of time (e.g., about 1 to about 10 minutes). Subsequently, the periodic acid is rinsed or washed from the sample, e.g., using a buffer, distilled water, or other wash reagent.

In some embodiments, the dye composition, the sulfite or SO₂ source composition, and/or the optional acid composition are dispensed sequentially to the substrate such that a Schiff's reagent may be synthesized in situ. In other embodiments, the dye composition, the sulfite or SO₂ source composition, and/or the optional acid composition are dispensed simultaneously to the substrate such that a Schiff's reagent may be synthesized in situ.

In some embodiments, the order in which the dye composition, the sulfite or SO₂ source composition, and/or the optional acid composition are dispensed depends upon the components included within the compositions. For instance, in some embodiments if the dye composition includes an acid, then the dye composition including the acid may first be dispensed to a substrate, followed by dispensing the sulfite or SO₂ source composition to the substrate. In other embodiments, the sulfite or SO₂ source composition may be dispensed first to a substrate, and then the dye composition including an acid may be subsequently dispensed to the substrate. In yet other embodiments, a dye composition including an acid and a sulfite or SO₂ source composition are dispensed simultaneously to the substrate.

In some embodiments, a dye composition free of acid (or having a pH greater than about 6.9) is first dispensed to a substrate, and then an acid composition is dispensed to the substrate (such as to a fluid puddle including the dye composition free of acid), so as to lower the pH of the dye composition (e.g., to provide an acidified dye composition). In some embodiments, upon dispensing of the acid composition, the pH of the puddle decreases below 6.9, such as below 6.5, such as below 6, such as below 5.5, such as below 5, such as below 4.5, such as below 4, such as below 3.5, such as below 3, such as below 2.5, such as below 2, etc. Subsequently, the sulfite or SO₂ source composition may be dispensed to the generated acidified dye composition to provide an in situ synthesized Schiff's reagent.

In other embodiments, an acid composition is first dispensed, and then a dye composition free of an acid (or having a pH greater than 6.9) is next dispensed to generate an acidified dye composition on the surface of the substrate (e.g., an acidified composition have a pH of less than 6.9). Subsequently, the sulfite or SO₂ source composition may be dispensed to the generated acidified dye composition to provide the in situ synthesized Schiff's reagent.

In yet other embodiments, a dye composition free of acid (or having a pH greater than about 6.9) and an acid composition are dispensed simultaneously to the substrate such that when the dispensed dye composition and acid composition mix on the surface of the substrate, the pH of the dye composition is lowered to provide an acidified dye composition). Subsequently, the sulfite or SO₂ source composition may be dispensed to the generated acidified dye composition to provide the in situ synthesized Schiff's reagent.

In some embodiments, a sulfite or SO₂ source composition is first dispensed to a substrate, and then a dye composition free of acid (or having a pH greater than about 6.9) is dispensed to the substrate. Subsequently, an acid composition is dispensed to the substrate such that a Schiff's reagent is synthesized in situ. In other embodiments, a sulfite or SO₂ source composition is first dispensed to a substrate, and then an acid composition is dispensed to the substrate. Subsequently, a dye composition free of acid (or having a pH greater than about 6.9) is dispensed to the substrate such that a Schiff's reagent is synthesized in situ. In yet other embodiments, a sulfite or SO₂ source composition is first dispensed to a substrate, and then a dye composition free of an acid and an acid composition are simultaneously applied to the substrate such that a Schiff's reagent is synthesized in situ.

In some embodiments, the amounts of the dye composition, the sulfite or SO₂ source composition, and the optional acid composition dispensed to the substrate independently range from between about between about 25 μL to about 500 μL, from between about between about 25 μL to about 400 μL, from between about between about 25 μL to about 300 μL, from between about between about 50 μL to about 300 μL, from between about between about 50 μL to about 250 μL, from between about between about 50 μL to about 225 μL, from between about between about 50 μL to about 200 μL, from between about between about 50 μL to about 175 μL, from between about between about 50 μL to about 150 μL, or from between about between about 100 μL to about 150 μL. By way of example only, between about 50 μL to about 200 μL of a dye composition and between about 50 μL to about 200 μL of a sulfite or SO₂ source composition may be dispensed, simultaneously or sequentially, to a substrate.

In some embodiments, the in situ synthesized Schiff's reagent is permitted to remain in contact with the sample for a predetermined amount of time. In this manner, the stain intensity of the Schiff's reagent may be “dialed in” to meet a pathologist's or medical professional's preferences; to account for differences in the components utilized in synthesizing the Schiff's reagent or the concentrations of the components utilized in any of the compositions described herein (e.g., dye concentration, acid concentration, and/or sulfite source concentration); to account for differences in sample types or sample fixation; and/or to account for differences in temperature of the sample and/or composition components. In some embodiments, the in situ synthesized Schiff's reagent is permitted to remain in contact with the sample for at least 1 minute, for at least 2 minutes, for at least 4 minutes, for at least 8 minutes, for at least 12 minutes, for at least 16 minutes, for at least 20 minutes, for at least 24 minutes, for at least 30 minutes, for at least 40 minutes, for at least 50 minutes, for at least 60 minutes, for at least 80 minutes, for at least 100 minutes, or for at least 120 minutes.

In some embodiments, the sample and/or the compositions for forming the in situ synthesized Schiff's reagent are maintained at predetermined temperature. For instance, the predetermined temperature is a temperature above 25° C., above 30° C., or above 35° C. In other embodiments, the temperature of the sample and/or the compositions for forming the in situ synthesized Schiff's reagent ranges from between about 30° C. to about 90° C., from between about 30° C. to about 50° C., from between about 30° C. to about 40° C., or from between about 35° C. to about 41° C. In yet further embodiments, the temperature of the sample and/or the compositions for forming the in situ synthesized Schiff's reagent is about 30° C. In yet further embodiments, the temperature of the sample and/or the compositions for forming the in situ synthesized Schiff's reagent is about 32° C. In yet further embodiments, the temperature of the sample and/or the compositions for forming the in situ synthesized Schiff's reagent is about 35° C. In yet further embodiments, the temperature of the sample and/or the compositions for forming the in situ synthesized Schiff's reagent is about 37° C. In yet further embodiments, the temperature of the sample and/or the compositions for forming the in situ synthesized Schiff's reagent is about 40° C.

In some embodiments if the specimen is a sample embedded in paraffin, the sample can be deparaffinized using appropriate deparaffinizing fluid(s). After a waste remover removes the deparaffinizing fluid(s), any number of substances can be successively applied to the specimen. The substances can be for pretreatment (e.g., protein-crosslinking, expose nucleic acids, etc.), denaturation, hybridization, washing (e.g., stringency wash), detection (e.g., link a visual or marker molecule to a probe), amplifying (e.g., amplifying proteins, genes, etc.), counterstaining, coverslipping, or the like.

After the specimens are processed, a user can transport specimen-bearing slides to an imaging apparatus for analysis or other downstream processing. For example, the imaging apparatus may be a brightfield imager slide scanner. One brightfield imager is the iScan Coreo™ brightfield scanner sold by Ventana Medical Systems, Inc. In automated embodiments, the imaging apparatus is a digital pathology device as disclosed in International Patent Application No.: PCT/US2010/002772 (Patent Publication No.: WO/2011/049608) entitled IMAGING SYSTEM AND TECHNIQUES or disclosed in U.S. Patent Application No. 61/533,114, filed on Sep. 9, 2011, entitled IMAGING SYSTEMS, CASSETTES, AND METHODS OF USING THE SAME. International Patent Application No. PCT/US2010/002772 and U.S. Patent Application Publication No. 2014/0178169 are incorporated by reference in their entities. In other embodiments, the imaging apparatus includes a digital camera coupled to a microscope.

The methods disclosed herein may be adapted for use with existing automated processing systems. For example, Ventana Medical Systems, Inc. is the assignee of a number of United States patents disclosing systems and methods for performing automated analyses, including U.S. Pat. Nos. 5,650,327, 5,654,200, 6,296,809, 6,352,861, 6,827,901 and 6,943,029, and U.S. published application Nos. 20030211630 and 20040052685, each of which is incorporated herein by reference. These systems may be adapted to be compatible with the present invention. Briefly, the automated slide processing systems that are described in the aforementioned references are high-volume slide processing systems that shuttle trays holding a plurality of slides in substantially horizontal positions (to minimize cross-contamination) between workstations that perform various slide processing operations on the slides. Fresh reagents can be applied to each slide during processing, and cross-contamination of slides with reagents can be substantially eliminated, because the slides are treated separately in spaced-apart fashion in the tray. In one configuration, the system includes a radiant heater, a combined de-paraffinizer/stainer/solvent exchanger workstation, a convection oven and a coverslipper. In some embodiments, a tray of slides bearing paraffin-embedded tissue samples can be heated under the radiant heater of the system to spread the paraffin in the samples for easier removal and also to adhere the samples to the slides. In some embodiments, the tray can then be transported to the multifunctional de-paraffinizer/stainer/solvent exchanger workstation, where slides can be deparaffinized, stained, and solvent exchanged. In some embodiments, a tray of stained slides that is ready for coverslipping can then be shuttled to the coverslipper of the system, where coverslips are added to the slides. Once the slides are coverslipped, the tray can then be transported to the convection oven to cure the coverslips on the stained slides. In some embodiments, the high volume stainer just described is commercially available from Ventana Medical Systems, Inc, Tucson, Ariz.

Examples of other commercially available specimen processing systems through which the solutions and formulations described herein may be applied include the VENTANA SYMPHONY (individual slide stainer) and the VENTANA HE 600 (individual slide stainer) series, as-well as the Dako CoverStainer (batch stainer) from Agilent Technologies, the Leica ST4020 Small Linear Stainer (batch stainer), Leica ST5020 Multistainer (batch stainer), and the Leica ST5010 Autostainer XL series (batch stainer) H&E stainers from Leica Biosystems Nussloch GmbH.

In some embodiments, an automated staining system includes one or more reservoirs, containers, and/or dispensers each of which may include any of the compositions disclosed herein. In some embodiments, the dye composition, the sulfite or SO₂ source composition, and the optional acid composition are separately dispensed onto the biologically sample. In these embodiments, the solutions can be allowed to mix by diffusion on the sample or mechanically mixed, for example, by agitation, such as with an air mixer or with a pipette.

In some embodiments, the automated specimen processing apparatus may include a carousel for holding a plurality of substrates, e.g., microscope slides, wherein each substrate includes a sample to be stained. In some embodiments, the automatic staining equipment can also include a device for rotating the carousel at predetermined speeds and a mechanism for directing and controlling application of reagents, including the solutions and formulations described herein, onto the substrates and samples during rotation of the carousel. In some embodiments, once the slides are loaded into the instrument, test protocols will dictate which compositions (from which reservoirs, dispensers, or containers) are dispensed onto the substrates at specific times. At the appropriate time, in some embodiments, a dispenser rack will rotate to align a correct composition over a substrate and the instrument will dispense a predetermined amount of one or more of the disclosed compositions onto the substrate.

In some embodiments, the system is an automated slide processing system that includes a slide tray holding a plurality of slides in a substantially horizontal position (such as in two rows where the slides are held at an angle between about 0.2 degrees and about 1.2 degrees from horizontal) and one or more workstations (for example, arranged in a vertical stack) that receive the slide tray and perform one or more slide processing operations on slides in the slide tray. In some embodiments, the workstation can perform a slide processing operation on one or more individual slides in a slide tray, for example, at least two or four slides in a slide tray, or it can simultaneously perform a slide processing operation on all of the slides in a slide tray. In some embodiments, the one or more workstations dispense a reagent to slides in the slide tray without a substantial amount of the reagent that contacts a first slide contacting a second slide, thereby minimizing cross-contamination between slides. Such workstations can include one or more directional nozzles that dispense the compositions of the present disclosure onto the slides. For example, the one or more directional nozzles can include a pair of directional nozzles that dispense the dye composition, the sulfite or SO₂ source composition, and/or the optional acid composition in opposite directions across a surface of a slide. In more particular embodiments, the one or more directional nozzles can further include a directional nozzle that dispenses the compositions towards a bottom surface of a slide. In other particular embodiments, the one or more workstations can simultaneously dispense the dye composition, the sulfite or SO₂ source composition, and/or the optional acid composition to at least two slides held in a slide tray within a given workstation, or the one or more workstations can simultaneously dispense a composition to all of the slides held in the slide tray within a given workstation. Additional system components and tray configurations (as well as control systems) are described in U.S. Pat. Nos. 8,663,991, 7,468,161, and 9,528,918, the disclosures of which are hereby incorporated by reference herein in their entireties.

In some embodiments, the present disclosure provides an apparatus for automatically treating biological specimens, comprising: at least one slide tray holding a plurality of slides in substantially horizontal positions, wherein said biological specimens are located on said slides; one or more workstations that receive said slide tray and perform one or more slide processing operations on said plurality of slides held in said slide tray; a transporter that moves said slide tray into and out of said one or more workstations; a fluidics module in fluid communication with said one or more workstations that supplies the dye composition, the sulfite or SO₂ source composition, and/or the optional acid composition to the one or more workstations; a pneumatics module in fluid communication with said one or more workstations and said fluidics module; wherein said pneumatics module supplies vacuum and/or pressurized gas to said one or more workstations and said fluidics module; and a control module in electrical communication with said transporter, said one or more workstations, said fluidics module, and said pneumatics module, wherein said control module coordinates function of components of the apparatus during treatment of said biological specimens. The apparatus may be adapted for delivering one or more of the dye compositions, the sulfite or SO₂ source composition, and/or the optional acid composition described herein, such as sequentially or simultaneously.

### EXAMPLES

### Example 1—Stability of Reagents for On-Slide Synthesis

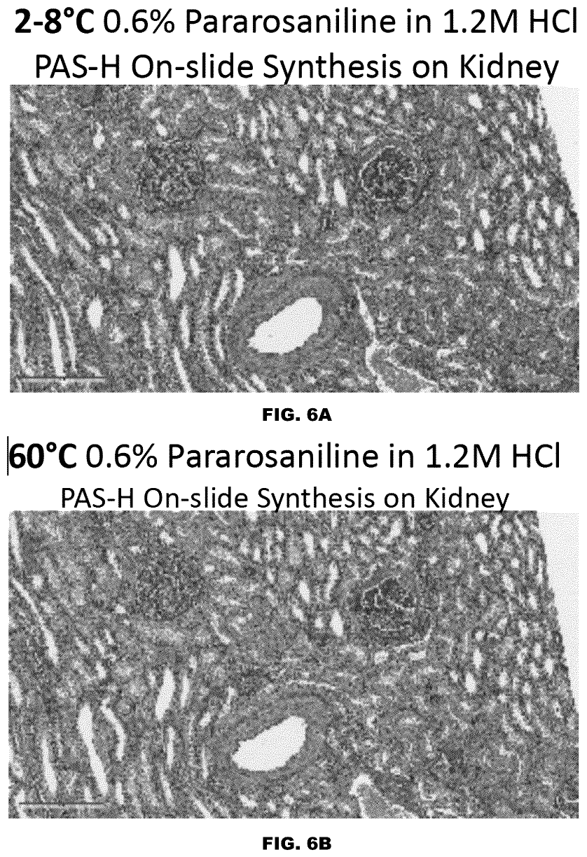

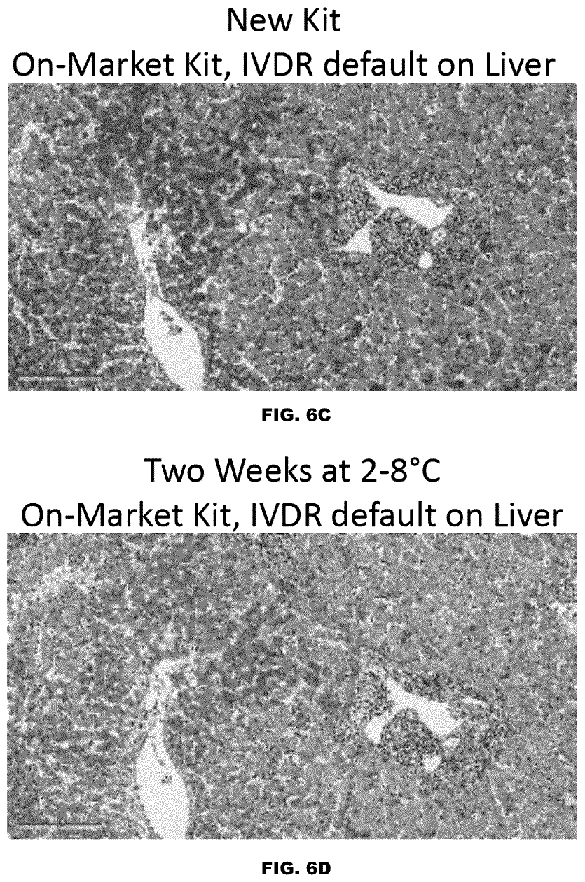

Applicants have discovered that the in situ synthesized Schiff's reagent facilitates staining of biological samples in an equivalent manner to the staining observed using commercial Schiff's reagents even after the dyes used to synthesize the Schiff's reagents were stored at elevated temperatures for extended periods of time (e.g., 60° C. for two weeks). For instance, FIGS. 6A and 6B show staining of a tissue sample performed using an in situ synthesized Schiff's reagent prepared from pararosaniline dyes stored for two weeks either at 2° C.-8° C. or at 60° C. Notably, the in situ synthesized Schiff's reagents stained equivalently regardless of the storage conditions of the precursor dye. In comparison, FIGS. 6C and 6D show staining of a tissue sample performed using commercial Schiff's reagents which were new (FIG. 6C) and opened for two weeks (FIG. 6D). Notably, the commercial Schiff's reagent which was opened for two weeks had a reduced staining intensity as compared with the newly opened commercial Schiff's reagent or those Schiff's reagents prepared in situ.

### Example 2—Reaction Time

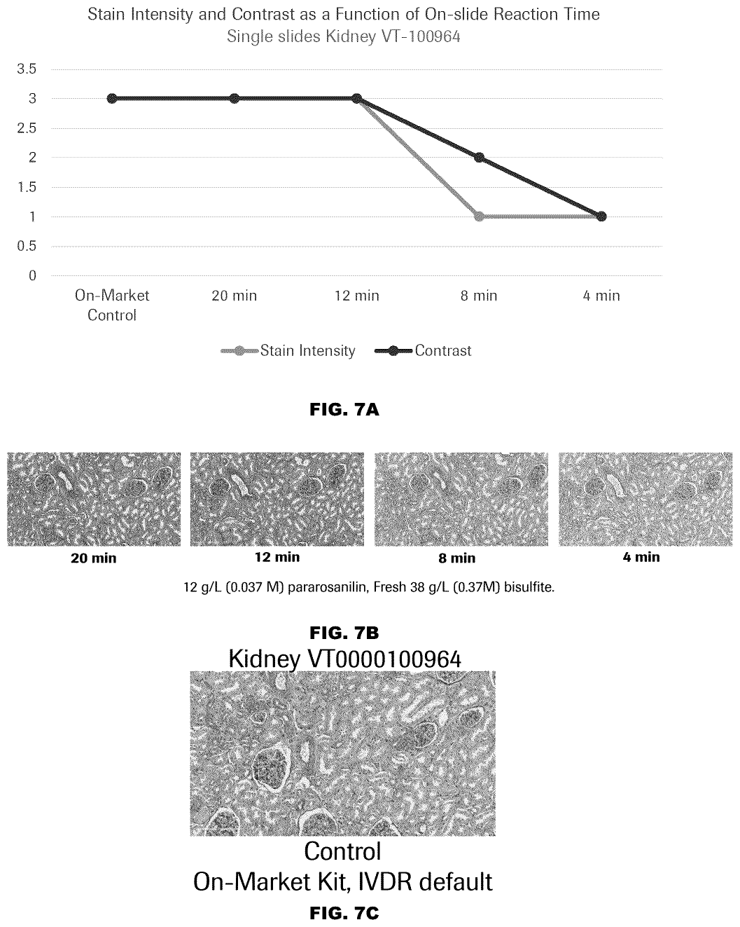

FIGS. 7A and 7B demonstrates staining intensity and contrast using an in situ synthesized Schiff's reagent as a function of reaction time. Time and temperature during incubation of the in situ synthesized Schiff's reagent on the tissue sample were varied simultaneously and individually to demonstrate that the intensity of staining could be adjusted to preference. Shorter incubation times between about 4 and about 16 minutes and/or lower temperature, e.g., 37° C., led to lighter staining intensities. Higher incubation times and temperatures, e.g., between about 16 to about 32 minutes and/or between about 40 to about 60° C. led to darker staining intensities. Notably, as the in situ synthesized Schiff's reagent remained in contact with the sample for longer periods of time, the staining intensity and/or contrast increased. This establishes that the staining intensity and/or contrast can be “dialed in” by varying the time (and/or temperature) the in situ synthesized Schiff's reagent remains in contact with the biological sample. As compared with a control sample stained using a commercial Schiff's reagent (FIG. 7C), the samples stained with the in situ synthesized Schiff's reagent had at least equivalent staining performance.

### Example 3—Dye Concentration

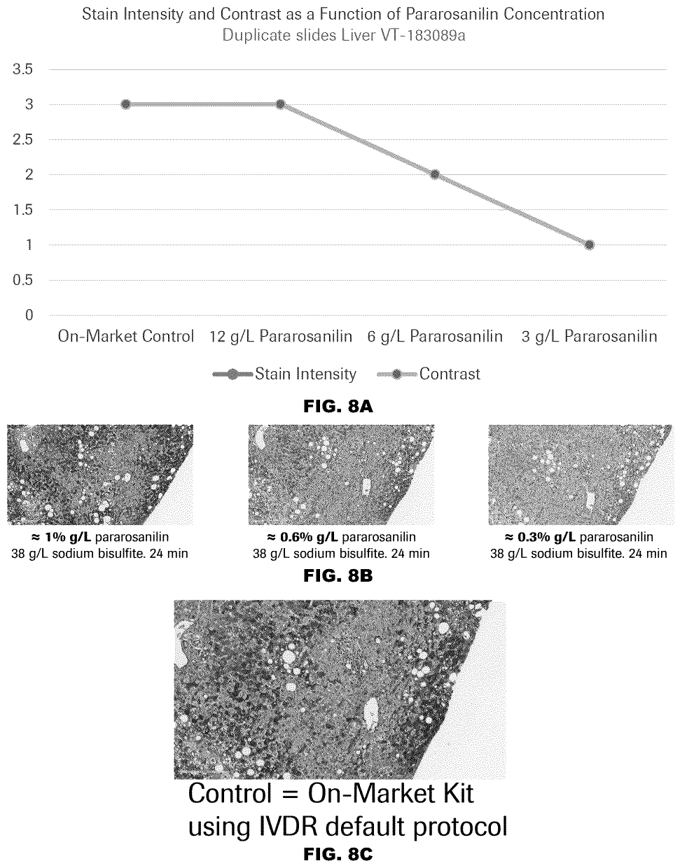

FIGS. 8A and 8B demonstrates staining intensity and contrast using an in situ synthesized Schiff's reagent as a function of the concentrations of the dye and sulfite/SO₂ source. For thiosulfate, from between about 0.02 to about 0.8M was tested. At 0.02M, the conditions were about equimolar to the 0.6% pararosaniline so staining was very weak. Notably, as the concentration of dye increased (as the concentration of the sulfite or SO₂ source is held constant), the staining intensity and/or contrast increased. For strong acid concentration, we tested down to 0.01M and up to 4M. Lower acid concentrations lead to darker staining. This establishes that the staining intensity and/or contrast can me “dialed in” by varying the concentration of dye utilized in the in-situ synthesis of a Schiff's reagent. As compared with a control sample stained using a commercial Schiff's reagent (FIG. 8C), the samples stained with the in situ synthesized Schiff's reagent had at least equivalent staining performance.

### Additional Embodiments

Additional Embodiment 1. A dye composition comprising a compound having any one of Formulas (I)—(XII):

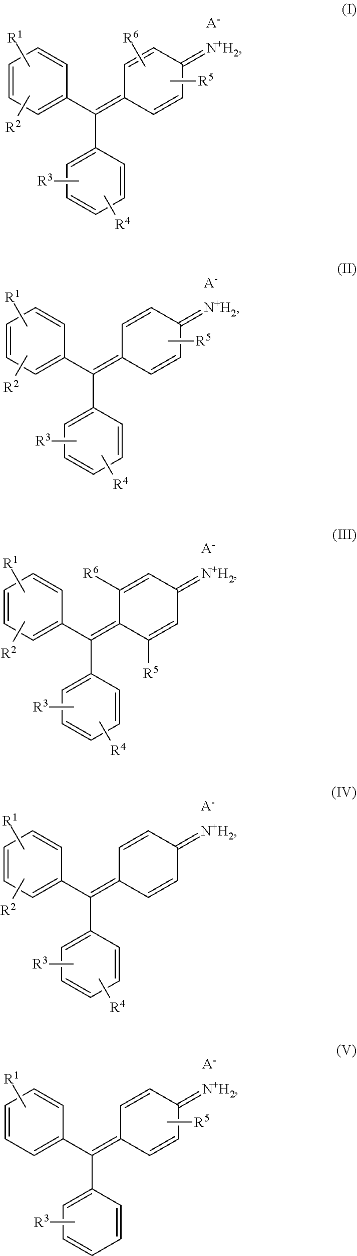

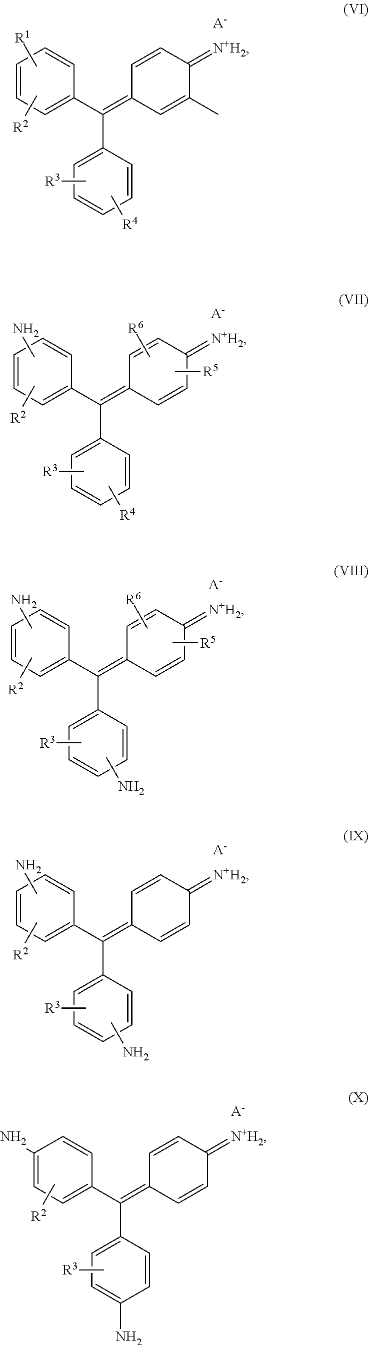

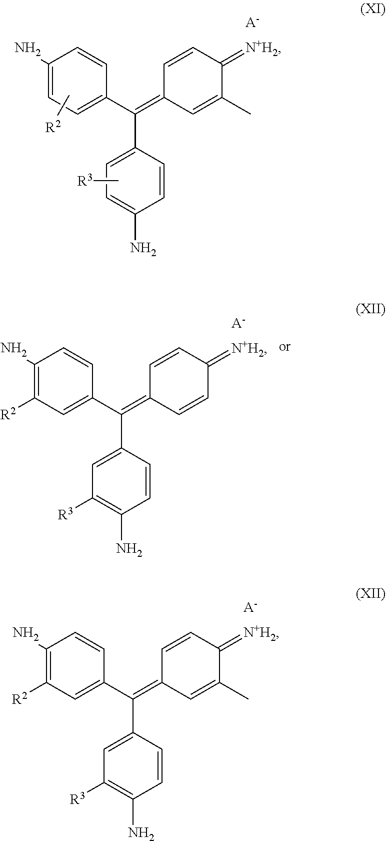

wherein
R¹, R², R³, R⁴, R⁵, and R⁶ are independently H, a halogen, a branched or unbranched, substituted or unsubstituted C₁-C₆ alkyl group or cycloalkyl group, —OH, —O—C₁-C₆ alkyl, or —N(R^{x})(R^{y}), where R^{x} and R^{y} are independently H or a branched or unbranched C₁-C₆ alkyl group optionally substituted with one or more halogen atoms, or where either R¹ and R² together, or R³ and R⁴ together, or R⁵ or R⁶ together form a 5- or 6-membered cyclic ring or heterocyclic ring which may be optionally substituted with one or more C₁-C₆ alkyl groups or one or more —N(R^{x}) (R^{y}) groups; and
A is a counterion; and
wherein a concentration of the compound having any one of Formulas (I)—(XII) ranges from between about 0.05% w/v to about 8% w/v by total volume of the dye composition.

Additional Embodiment 2. The dye composition of additional embodiment 1, wherein at least two of R¹, R², R³, R⁴, R⁵, and R⁶ are —N(R^{x})(R^{y}) and wherein at least another two of R¹, R², R³, R⁴, R⁵, and R⁶ are a branched or unbranched, substituted or unsubstituted C₁-C₆ alkyl group or cycloalkyl group; and wherein at least one of R^{x} or R^{y} is H.

Additional Embodiment 3. The dye composition of additional embodiment 1, wherein at least two of R¹, R², R³, R⁴, R⁵, and R⁶ are —N(R^{x})(R^{y}) and wherein at least another two of R¹, R², R³, R⁴, R⁵, and R⁶ are C₁-C₂ alkyl group; and wherein at least one of R^{x} or R^{y} is H.

Additional Embodiment 4. The dye composition of additional embodiment 1, wherein the compound having any one of Formulas (I) to (XII) is selected from the group consisting of:

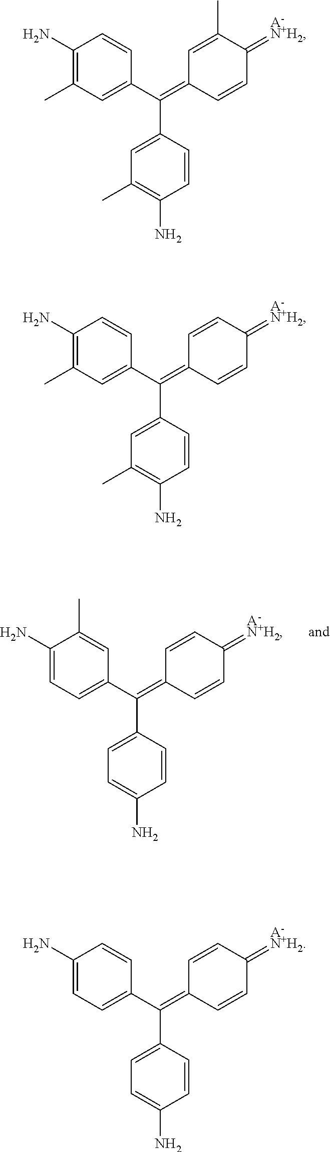

Additional Embodiment 5. The dye composition of any one of additional embodiments 1 to 4, wherein the compound having any one of Formulas (I) to (XII) has a molecular weight ranging from between about 300 g/mol to about 600 g/mol.

Additional Embodiment 6. The dye composition of any one of additional embodiments 1 to 4, wherein the compound having any one of Formulas (I) to (XII) has a molecular weight ranging from between about 300 g/mol to about 425 g/mol.

Additional Embodiment 7. The dye composition of any one of additional embodiments 1 to 6, wherein the concentration ranges from between about 0.15% w/v to about 2.5% w/v by total volume of the dye composition.

Additional Embodiment 8. The dye composition of any one of additional embodiments 1 to 6, wherein the concentration ranges from between about 0.15% w/v to about 1.8% w/v by total volume of the dye composition.

Additional Embodiment 9. The dye composition of any one of additional embodiments 1 to 8, further comprising an acid.

Additional Embodiment 10. The dye composition of additional embodiment 9, wherein the acid is a strong acid.

Additional Embodiment 11. The dye composition of additional embodiment 10, wherein the strong acid is 1M to 1.3M hydrochloric acid.

Additional Embodiment 12. The dye composition of additional embodiment 10, wherein the strong acid is 1M to 1.3M nitric acid.

Additional Embodiment 13. The dye composition of any one of additional embodiments 1-9, further comprising at least one of a solvent and/or an additive.

Additional Embodiment 14. The dye composition of any one of additional embodiments 1-9, further comprising a solvent and at least one additive.

Additional Embodiment 15. The dye composition of additional embodiment 1, consisting essentially of the compound having any one of Formulas (I) to (XII) and a strong acid.

Additional Embodiment 16. A sulfite composition comprising a sulfite or SO₂ source selected from the group consisting of metabisulfite, bisulfite, dithionite, thiosulfate, sulfites, and sulfurous acid; wherein a concentration of the sulfite or SO₂ source ranges from between about 0.1% w/v to about 18% w/v by total weight of the sulfite composition.

Additional Embodiment 17. The sulfite composition of additional embodiment 16, wherein the concentration ranges from between about 1% w/v to about 9% w/v by total weight of the sulfite composition.

Additional Embodiment 18. The sulfite composition of additional embodiment 16, wherein the concentration ranges from between about 1% w/v to about 4% w/v by total weight of the sulfite composition.

Additional Embodiment 19. The sulfite composition of additional embodiment 16, wherein the sulfite or SO₂ source is not thiosulfate.

Additional Embodiment 20. The sulfite composition of additional embodiment 19, wherein the sulfite composition further comprises an acid.

Additional Embodiment 21. A kit comprising (i) the dye composition of any one of additional embodiments 1-15; and (ii) the sulfite composition of any one of additional embodiments

Additional Embodiment 22. A kit comprising (i) a dye composition which is free from an acid; (ii) a sulfite composition; and (iii) an acid, wherein each of the dye composition, the sulfite composition, and the acid are present in separate vessels.

Additional Embodiment 23. The kit of additional embodiment 22, wherein the dye composition comprises a compound having any one of Formulas (I)-(XII):

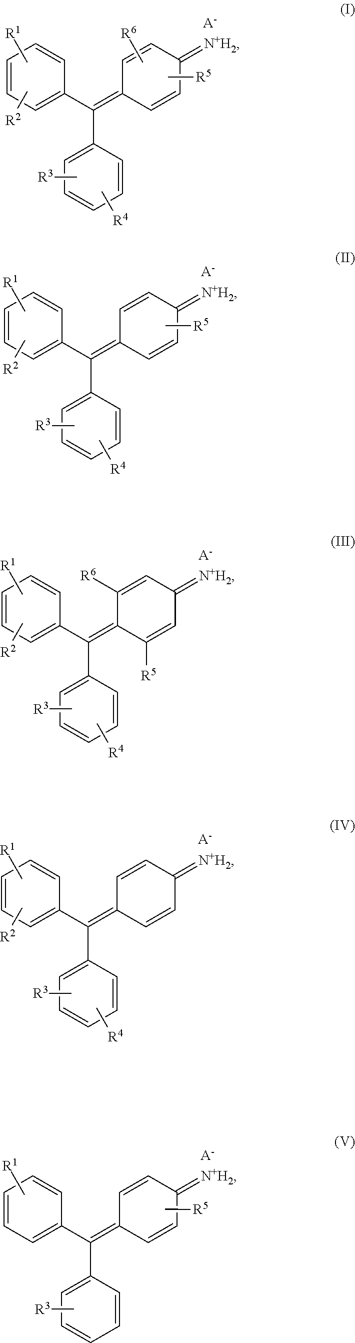

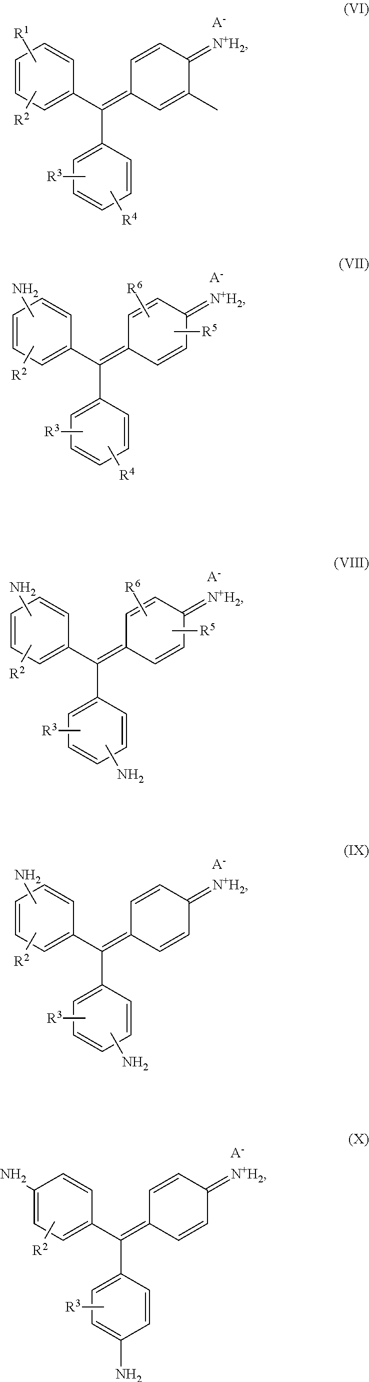

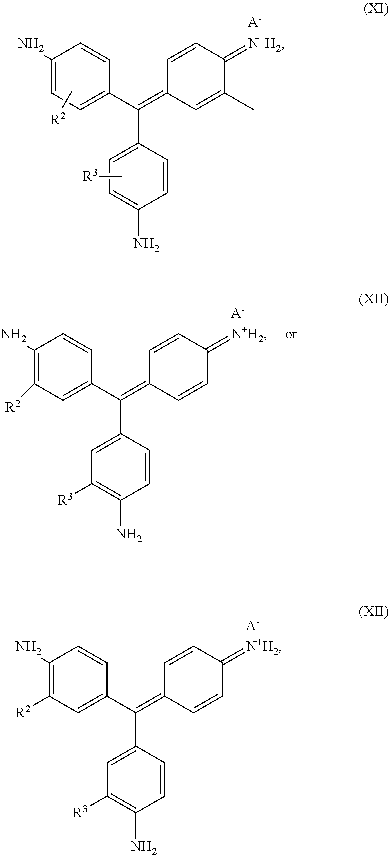

wherein
R¹, R², R³, R⁴, R⁵, and R⁶ are independently H, a halogen, a branched or unbranched, substituted or unsubstituted C₁-C₆ alkyl group or cycloalkyl group, —OH, —O—C₁-C₆ alkyl, or —N(R^{x})(R^{y}), where R^{x} and R^{y} are independently H or a branched or unbranched C₁-C₆ alkyl group optionally substituted with one or more halogen atoms, or where either R¹ and R² together, or R³ and R⁴ together, or R⁵ or R⁶ together form a 5- or 6-membered cyclic ring or heterocyclic ring which may be optionally substituted with one or more C₁-C₆ alkyl groups or one or more —N(R^{x}) (R^{y}) groups; and
A is a counterion; and
wherein a concentration of the compound having any one of Formulas (I)—(XII) ranges from between about 0.05% w/v to about 8% w/v by total volume of the dye composition.

Additional Embodiment 24. The kit of additional embodiment 23, wherein at least two of R¹, R², R³, R⁴, R⁵, and R⁶ are —N(R^{x})(R^{y}) and wherein at least another two of R¹, R², R³, R⁴, R⁵, and R⁶ are a branched or unbranched, substituted or unsubstituted C₁-C₆ alkyl group or cycloalkyl group; and wherein at least one of R^{x} or R^{y} is H.

Additional Embodiment 25. The kit of additional embodiment 23, wherein at least two of R¹, R², R³, R⁴, R⁵, and R⁶ are —N(R^{x})(R^{y}) and wherein at least another two of R¹, R², R³, R⁴, R⁵, and R⁶ are C₁-C₂ alkyl group; and wherein at least one of R^{x} or R^{y} is H.

Additional Embodiment 26. The kit of additional embodiment 23, wherein the compound having any one of Formulas (I) to (XII) is selected from the group consisting of:

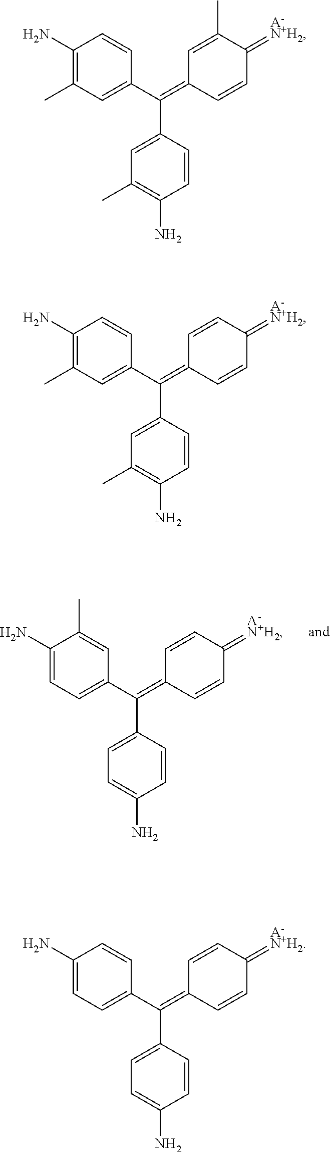

Additional Embodiment 27. The kit of any one of additional embodiments 23-26, wherein the compound having any one of Formulas (I) to (XII) has a molecular weight ranging from between about 300 g/mol to about 600 g/mol.

Additional Embodiment 28. The kit of any one of additional embodiments 23-26, wherein the compound having any one of Formulas (I) to (XII) has a molecular weight ranging from between about 300 g/mol to about 425 g/mol.

Additional Embodiment 29. The kit of any one of additional embodiments 23-28, wherein the dye concentration ranges from between about 0.15% w/v to about 2.5% w/v by total volume of the dye composition.

Additional Embodiment 30. The kit of any one of additional embodiments 23-28, wherein the dye concentration ranges from between about 0.15% w/v to about 1.8% w/v by total volume of the dye composition.

Additional Embodiment 31. The kit of any one of additional embodiments 23-30, wherein the sulfite composition comprises a sulfite or SO₂ source selected from the group consisting of metabisulfite, bisulfite, dithionite, thiosulfate, sulfites, and sulfurous acid; wherein a concentration of the sulfite or SO₂ source ranges from between about 0.1% w/v to about 18% w/v by total weight of the sulfite composition.

Additional Embodiment 32. The kit of additional embodiment 31, wherein the sulfite source concentration ranges from between about 1% w/v to about 9% w/v by total weight of the sulfite composition.

Additional Embodiment 33. The kit of additional embodiment 31, wherein the sulfite source concentration ranges from between about 1% w/v to about 4% w/v by total weight of the sulfite composition.

Additional Embodiment 34. The kit of any one or additional embodiments 23-31, wherein the acid is a strong acid.

Additional Embodiment 35. The kit of any one of additional embodiments 23-31, wherein the acid is selected from the group consisting of hydrochloric acid, hydrobromic acid, hydrofluoric, trifluoracetic, hydroiodic acid, sulfuric acid, nitric acid, chloric acid, and perchloric acid.

Additional Embodiment 36. A method of staining a biological sample, the method comprising sequentially dispensing the dye composition and the sulfite composition of the kit of additional embodiment 21 to the biological sample.

Additional Embodiment 37. The method of additional embodiment 36, wherein the dye composition is dispensed prior to the sulfite composition.

Additional Embodiment 38. The method of any one of additional embodiments 36-37, wherein the temperature of the sample, the dye composition, and/or the sulfite composition ranges from between 30° C. to about 50° C.

Additional Embodiment 39. The method of any one of additional embodiments 36-37, wherein the temperature of the sample, the dye composition, and/or the sulfite composition ranges from between 30° C. to about 40° C.

Additional Embodiment 40. The method of any one of additional embodiments 36-39, wherein the sequentially dispensed dye composition and the sulfite composition are allowed to remain in contact with the sample for at least 4 minutes.

Additional Embodiment 41. The method of any one of additional embodiments 36-39, wherein the sequentially dispensed dye composition and the sulfite composition are allowed to remain in contact with the sample for at least 8 minutes.

Additional Embodiment 42. The method of any one of additional embodiments 36-37, wherein an amount of the dye composition dispensed to the sample ranges from between about 50 μL to about 200 μL; and wherein an amount of the sulfite composition dispensed to the sample ranges from between about 50 μL to about 200 μL.

Additional Embodiment 43. The method of any one of additional embodiments 36-37, wherein an amount of the dye composition dispensed to the sample ranges from between about 100 μL to about 200 μL; and wherein an amount of the sulfite composition dispensed to the sample ranges from between about 100 μL to about 200 μL.

Additional Embodiment 44. The method of any one of additional embodiments 36-37, wherein an amount of the dye composition dispensed to the sample ranges from between about 100 μL to about 150 μL; and wherein an amount of the sulfite composition dispensed to the sample ranges from between about 100 μL to about 150 μL.

Additional Embodiment 45. A method of staining a biological sample, the method comprising simultaneously dispensing the dye composition and the sulfite composition of the kit of additional embodiment 21 to the biological sample.

Additional Embodiment 46. The method of additional embodiment 45, wherein the temperature of the sample, the dye composition, and/or the sulfite composition ranges from between 30° C. to about 50° C.

Additional Embodiment 47. The method of additional embodiment 45, wherein the temperature of the sample, the dye composition, and/or the sulfite composition ranges from between 30° C. to about 40° C.

Additional Embodiment 48. The method of any one of additional embodiments 45-47, wherein the simultaneously dispensed dye composition and sulfite composition are allowed to remain in contact with the sample for at least 4 minutes.

Additional Embodiment 49. The method of any one of additional embodiments 45-47, wherein the simultaneously dispensed dye composition and sulfite composition are allowed to remain in contact with the sample for at least 8 minutes.

Additional Embodiment 50. The method of any one of additional embodiments 45-47, wherein an amount of the dye composition dispensed to the sample ranges from between about 50 μL to about 200 μL; and wherein an amount of the sulfite composition dispensed to the sample ranges from between about 50 μL to about 200 μL.

Additional Embodiment 51. The method of any one of additional embodiments 45-47, wherein an amount of the dye composition dispensed to the sample ranges from between about 100 μL to about 200 μL; and wherein an amount of the sulfite composition dispensed to the sample ranges from between about 100 μL to about 200 μL.

Additional Embodiment 52. The method of any one of additional embodiments 45-47, wherein an amount of the dye composition dispensed to the sample ranges from between about 100 μL to about 150 μL; and wherein an amount of the sulfite composition dispensed to the sample ranges from between about 100 μL to about 150 μL.

Additional Embodiment 53. A method of staining a biological sample, the method comprising sequentially dispensing the dye composition, the sulfite composition, and the acid of the kit of any one or additional embodiments 23-35 to the biological sample.

Additional Embodiment 54. The method of additional embodiment 53, wherein the dye composition is dispensed prior to the sulfite composition and/or the acid.

Additional Embodiment 55. The method of any one of additional embodiments 53-54, wherein the temperature of the sample, the dye composition, the acid, and/or the sulfite composition ranges from between 30° C. to about 50° C.

Additional Embodiment 56. The method of any one of additional embodiments 53-54, wherein the temperature of the sample, the dye composition, the acid, and/or the sulfite composition ranges from between 30° C. to about 40° C.

Additional Embodiment 57. The method of any one of additional embodiments 53-56, wherein the sequentially dispensed dye composition, the acid, and the sulfite composition are allowed to remain in contact with the sample for at least 4 minutes.

Additional Embodiment 58. The method of any one of additional embodiments 53-56, wherein the sequentially dispensed dye composition, the acid, and the sulfite composition are allowed to remain in contact with the sample for at least 8 minutes.

Additional Embodiment 59. The method of any one of additional embodiments 53-56, wherein an amount of the dye composition dispensed to the sample ranges from between about 50 μL to about 200 μL; wherein an amount of the acid dispensed to the sample ranges from between about 50 μL to about 200 μL; and wherein an amount of the sulfite composition dispensed to the sample ranges from between about 50 μL to about 200 μL.

Additional Embodiment 60. The method of any one of additional embodiments 53-56, wherein an amount of the dye composition dispensed to the sample ranges from between about 100 μL to about 200 μL; wherein an amount of the acid dispensed to the sample ranges from between about 100 μL to about 200 μL; and wherein an amount of the sulfite composition dispensed to the sample ranges from between about 100 μL to about 200 μL.

Additional Embodiment 61. The method of any one of additional embodiments 53-56, wherein an amount of the dye composition dispensed to the sample ranges from between about 100 μL to about 150 μL; wherein an amount of the acid dispensed to the sample ranges from between about 100 μL to about 150 μL; and wherein an amount of the sulfite composition dispensed to the sample ranges from between about 100 μL to about 150 μL.

Additional Embodiment 62. A method of staining a biological sample, the method comprising simultaneously dispensing the dye composition, the sulfite composition, and the acid of the kit of any one or additional embodiments 23-35 to the biological sample.

Additional Embodiment 63. The method of additional embodiment 62, wherein the temperature of the sample, the dye composition, the acid, and/or the sulfite composition ranges from between 30° C. to about 50° C.

Additional Embodiment 64. The method of any one of additional embodiments 62-63, wherein the temperature of the sample, the dye composition, the acid, and/or the sulfite composition ranges from between 30° C. to about 40° C.

Additional Embodiment 65. The method of any one of additional embodiments 62-64, wherein the simultaneously dispensed dye composition, the acid, and the sulfite composition are allowed to remain in contact with the sample for at least 4 minutes.

Additional Embodiment 66. The method of any one of additional embodiments 62-64, wherein the simultaneously dispensed dye composition, the acid, and the sulfite composition are allowed to remain in contact with the sample for at least 8 minutes.

Additional Embodiment 67. The method of any one of additional embodiments 62-64, wherein an amount of the dye composition dispensed to the sample ranges from between about 50 μL to about 200 μL; wherein an amount of the acid dispensed to the sample ranges from between about 50 μL to about 200 μL; and wherein an amount of the sulfite composition dispensed to the sample ranges from between about 50 μL to about 200 μL.

Additional Embodiment 68. The method of any one of additional embodiments 62-64, wherein an amount of the dye composition dispensed to the sample ranges from between about 100 μL to about 200 μL; wherein an amount of the acid dispensed to the sample ranges from between about 100 μL to about 200 μL; and wherein an amount of the sulfite composition dispensed to the sample ranges from between about 100 μL to about 200 μL.

Additional Embodiment 69. The method of any one of additional embodiments 62-64, wherein an amount of the dye composition dispensed to the sample ranges from between about 100 μL to about 150 μL; wherein an amount of the acid dispensed to the sample ranges from between about 100 μL to about 150 μL; and wherein an amount of the sulfite composition dispensed to the sample ranges from between about 100 μL to about 150 μL.

Additional Embodiment 70. A stained biological sample, the stained biological sample prepared by (i) dispensing a dye composition to the biological sample, the dye composition comprising (a) a compound having a 4-Benzhydrylidene-2,5-cyclohexadien-1-imine core functionalized to include at least two substituted or unsubstituted amine groups, wherein the compound has a molecular weight ranging from between about 300 g/mol to about 600 g/mol; and (b) an acid; and wherein a concentration of the compound ranges from between about 0.15% w/v to about 2.5% w/v by total volume of the dye composition; and (ii) dispensing a sulfite composition comprising a sulfite or SO₂ source, wherein a concentration of the sulfite or SO₂ source ranges from between about 0.1% w/v to about 18% w/v by total weight of the sulfite composition. Additional Embodiment 71. The stained biological sample of additional embodiment 70, wherein the dye composition is dispensed first to the biological sample.

Additional Embodiment 72. The stained biological sample of additional embodiment 70, wherein the dye composition and the sulfite composition are dispensed simultaneously. Additional Embodiment 73. The stained biological sample of additional embodiment 70, wherein the acid is a strong acid.

Additional Embodiment 74. The stained biological sample of additional embodiment 70, wherein the compound is selected from the group consisting of

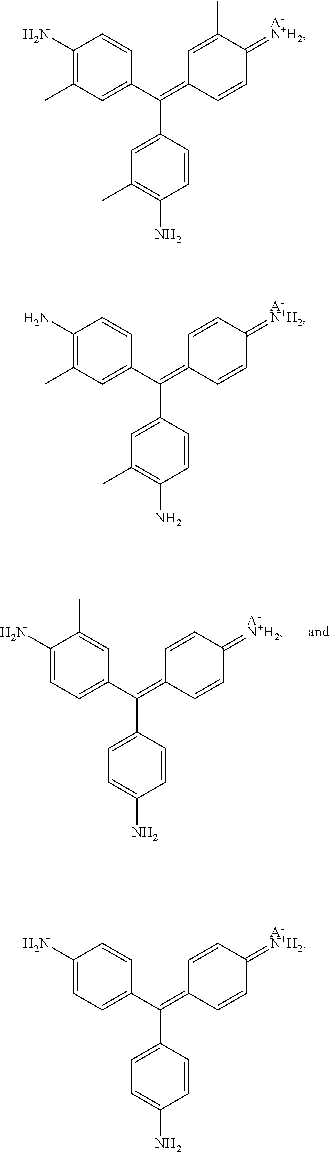

Additional Embodiment 75. The stained biological sample of additional embodiment 74, wherein the acid is hydrochloric acid or nitric acid.

All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary, to employ concepts of the various patents, applications and publications to provide yet further embodiments.

Although the disclosure herein has been described with reference to particular embodiments, it is to be understood that these embodiments are merely illustrative of the principles and applications of the present disclosure. It is therefore understood that numerous modifications may be made to the illustrative embodiments and that other arrangements may be devised without departing from the spirit and scope of the present disclosure as defined by the appended claims.

1. A kit comprising:
(i) a dye composition comprising a compound having any one of Formulas (I)—(XII): 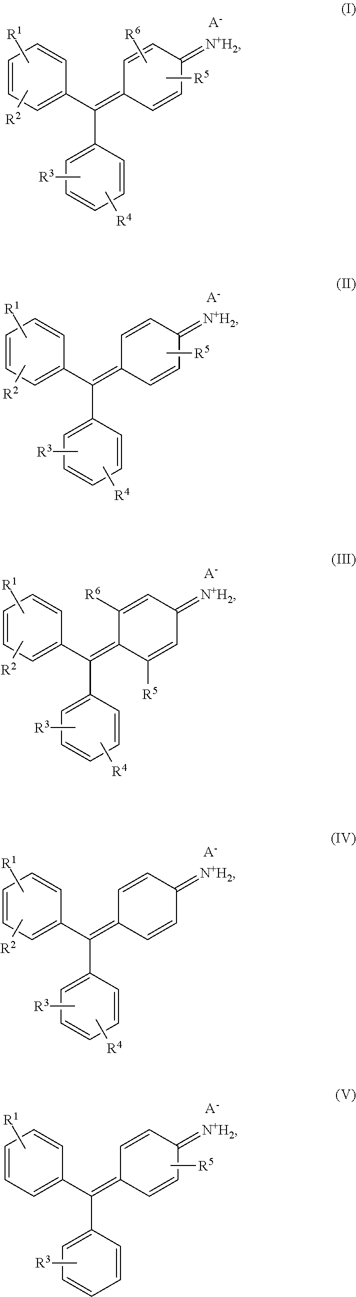 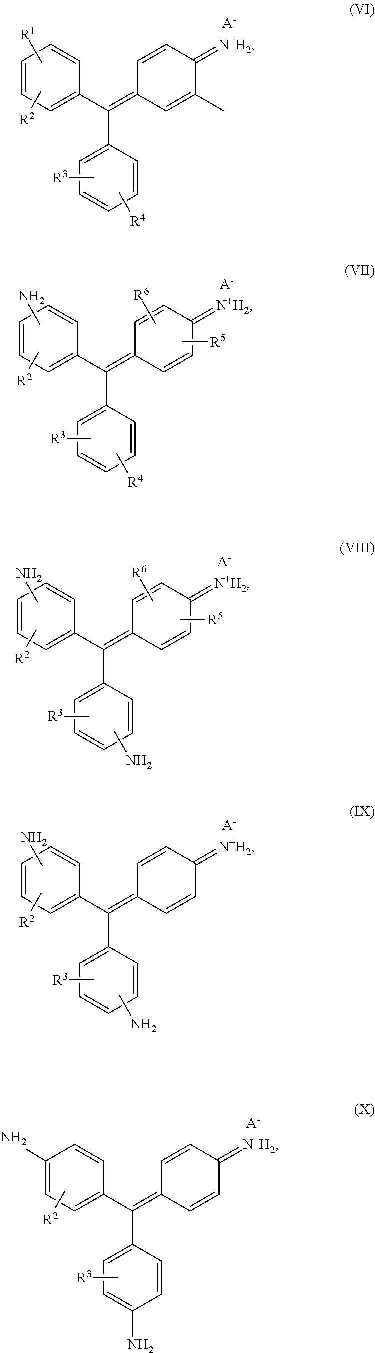 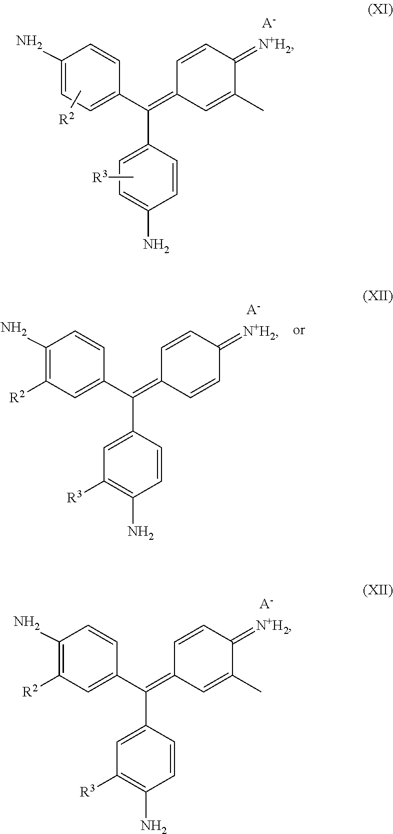
wherein
R¹, R², R³, R⁴, R⁵, and R⁶ are independently H, a halogen, a branched or unbranched, substituted or unsubstituted C₁-C₆ alkyl group or cycloalkyl group, —OH, —O—C₁-C₆ alkyl, or —N(R^{x})(R^{y}), where R^{x} and R^{y} are independently H or a branched or unbranched C₁-C₆ alkyl group optionally substituted with one or more halogen atoms, or where either R¹ and R² together, or R³ and R⁴ together, or R⁵ or R⁶ together form a 5- or 6-membered cyclic ring or heterocyclic ring which may be optionally substituted with one or more C₁-C₆ alkyl groups or one or more —N(R^{x})(R^{y}) groups; and
A is a counterion; and
wherein a concentration of the compound having any one of Formulas (I)—(XII) ranges from between about 0.05% w/v to about 8% w/v by total volume of the dye composition; and
(ii) a sulfite composition comprising a sulfite or SO₂ source selected from the group consisting of metabisulfite, bisulfite, dithionite, thiosulfate, sulfites, and sulfurous acid; wherein a concentration of the sulfite or SO₂ source ranges from between about 0.1% w/v to about 18% w/v by total weight of the sulfite composition.

2. The kit of claim 1, wherein the concentration of the sulfite or SO₂ source ranges from between about 1% w/v to about 9% w/v by total weight of the sulfite composition.

3. The kit of claim 1, wherein the concentration of the sulfite or SO₂ source ranges from between about 1% w/v to about 4% w/v by total weight of the sulfite composition.

4. The kit of claim 1, wherein the sulfite or SO₂ source is not thiosulfate.

5. The kit of claim 1, wherein the sulfite composition further comprises an acid.

6. The kit of claim 5, wherein the acid is a strong acid.

7. The kit of claim 6, wherein the strong acid is 1M to 1.3M hydrochloric acid.

8. The kit of claim 6, wherein the strong acid is 1M to 1.3M nitric acid.

9. The kit of claim 5, wherein the acid is selected from the group consisting of hydrochloric acid, hydrobromic acid, hydrofluoric, trifluoracetic, hydroiodic acid, sulfuric acid, nitric acid, chloric acid, and perchloric acid.

10. The kit of claim 1, wherein at least two of R¹, R², R³, R⁴, R⁵, and R⁶ are —N(R^{x})(R^{y}) and wherein at least another two of R¹, R², R³, R⁴, R⁵, and R⁶ are a branched or unbranched, substituted or unsubstituted C₁-C₆ alkyl group or cycloalkyl group; and wherein at least one of R^{x} or R^{y} is H.

11. The kit of claim 1, wherein at least two of R¹, R², R³, R⁴, R⁵, and R⁶ are —N(R^{x})(R^{y}) and wherein at least another two of R¹, R², R³, R⁴, R⁵, and R⁶ are C₁-C₂ alkyl group; and wherein at least one of R^{x} or R^{y} is H.

12. The kit composition of claim 1, wherein the compound having any one of Formulas (I) to (XII) is selected from the group consisting of:

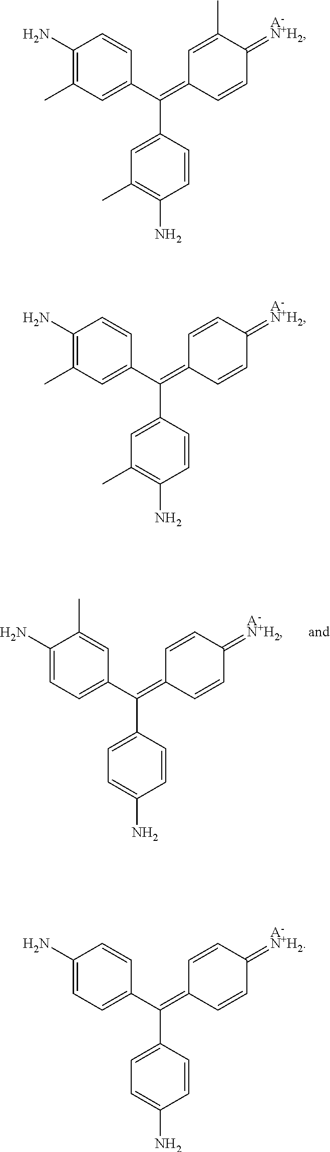

13. The kit of claim 1, wherein the compound having any one of Formulas (I) to (XII) has a molecular weight ranging from between about 300 g/mol to about 600 g/mol.

14. The kit of claim 1, wherein the compound having any one of Formulas (I) to (XII) has a molecular weight ranging from between about 300 g/mol to about 425 g/mol.

15. The kit of claim 1, wherein the concentration of the compound having any one of Formulas (I)—(XII) ranges from between about 0.15% w/v to about 2.5% w/v by total volume of the dye composition.

16. The kit of claim 1, wherein the concentration of the compound having any one of Formulas (I)—(XII) ranges from between about 0.15% w/v to about 1.8% w/v by total volume of the dye composition.

17. A compound having any one of Formulas (I)—(XII): 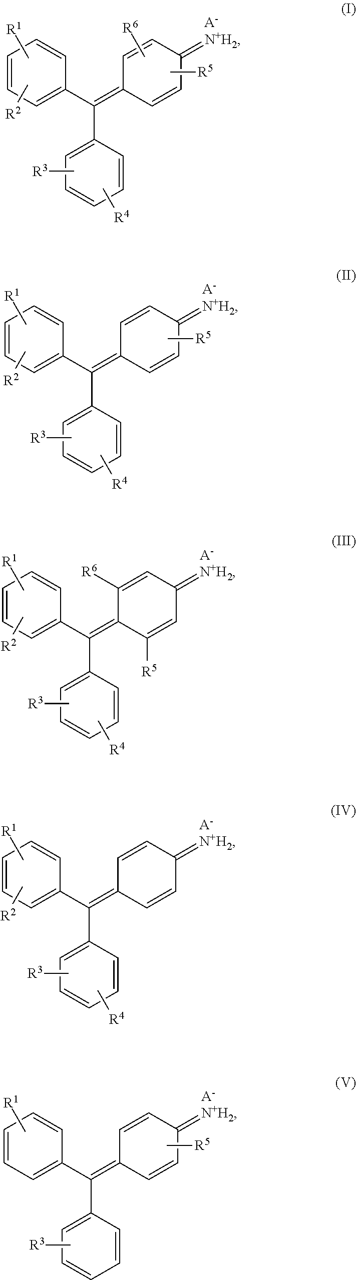 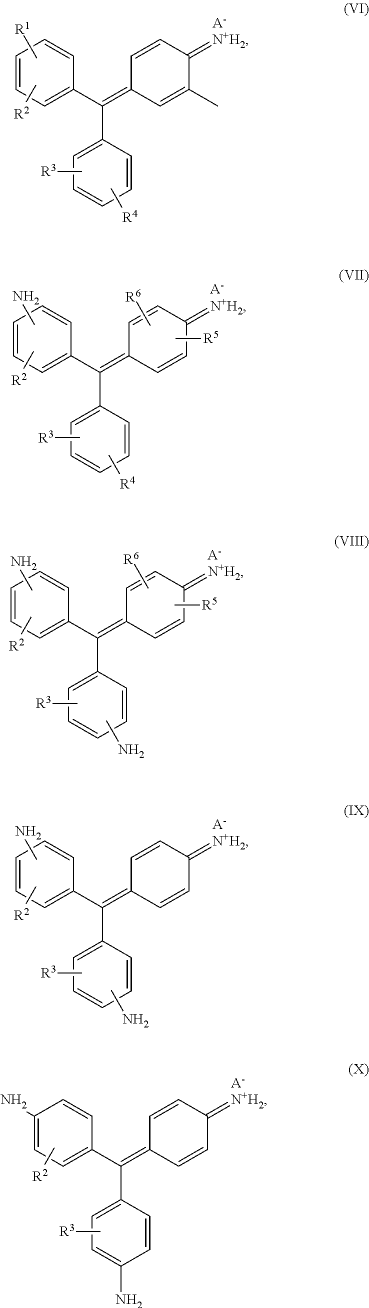 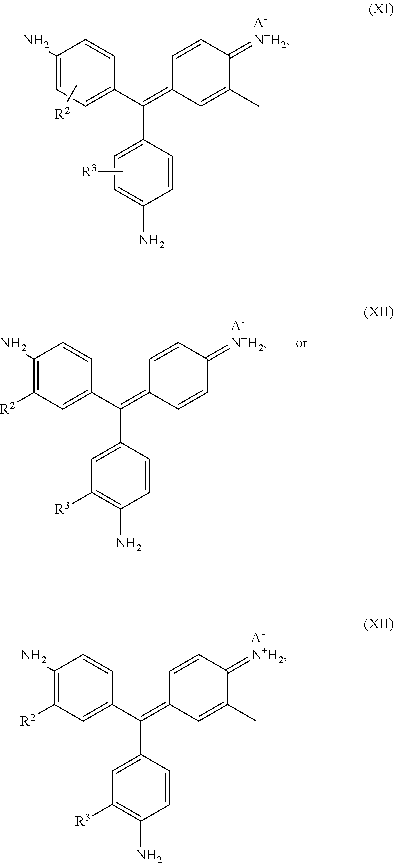
wherein
R¹, R², R³, R⁴, R⁵, and R⁶ are independently H, a halogen, a branched or unbranched, substituted or unsubstituted C₁-C₆ alkyl group or cycloalkyl group, —OH, —O—C₁-C₆ alkyl, or —N(R^{x})(R^{y}), where R^{x} and R^{y} are independently H or a branched or unbranched C₁-C₆ alkyl group optionally substituted with one or more halogen atoms, or where either R¹ and R² together, or R³ and R⁴ together, or R⁵ or R⁶ together form a 5- or 6-membered cyclic ring or heterocyclic ring which may be optionally substituted with one or more C₁-C₆ alkyl groups or one or more —N(R^{x})(R^{y}) groups; and
A is a counterion.

18. The compound of claim 17, wherein the compound is selected from the group consisting of:

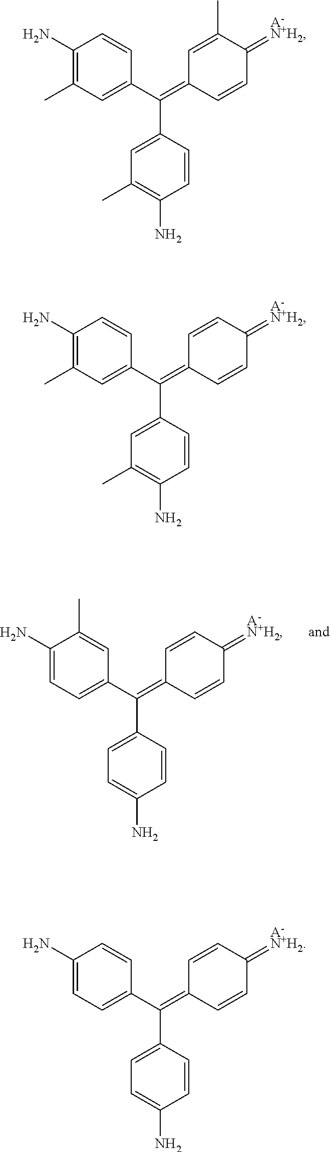

19. The compound of claim 17, wherein the compound has a molecular weight ranging from between about 300 g/mol to about 600 g/mol.

20. The compound of claim 17, wherein the compound has a molecular weight ranging from between about 300 g/mol to about 425 g/mol.
